(19) United States
(12) Patent Application Publication
(10) Pub. No.: US 2008/0075883 A1
(43) Pub. Date: Mar. 27, 2008

(54) PROCESS FOR PRODUCING MOLDED PRINTED MATERIAL, AND MOLDED PRINTED MATERIAL

(75) Inventors: Yuuichi HAYATA, Ashigarakami-gun (JP); Kotaro WATANABE, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/860,817

(22) Filed: Sep. 25, 2007

(30) Foreign Application Priority Data
Sep. 25, 2006 (JP) 2006-258698

(51) Int. Cl. B29C 71/02

(52) U.S. Cl. 427/542

(57) ABSTRACT

A process for producing a molded printed material is provided that includes (A) a step of forming an image by discharging an ink composition on a support by an inkjet method, the ink composition comprising at least one compound of monofunctional cationically polymerizable monomer selected from the group consisting of an oxetane compound, an oxirane compound, and a vinyl ether compound, and the proportion of the monofunctional cationically polymerizable monomer in the entire ink composition being at least 30 wt %, (B) a step of curing the ink composition by irradiating with actinic radiation the image obtained so as to obtain a printed material having the image cured on the support, and (C) a step of molding the printed material. There is also provided a molded printed material obtained by the process for producing a molded printed material.

### BACKGROUND OF THE INVENTION

1. Field of the Invention

The present invention relates to a process for producing a molded printed material, and to a molded printed material.

2. Description of the Related Art

Molded printed sheets (decorative sheets) are used today in various applications. For example, the surface sheet of a membrane switch used in an electrical product, etc. is produced by forming an image on a thin plastic sheet (PET, polycarbonate, polystyrene, etc. having a film thickness of about 100 μm) and then embossing it in order to impart a click feel to a switch portion (click portion). Furthermore, there are many cases in which, in order to give a printed material a matte appearance or a three-dimensional feel in design, the printed material is subjected to embossing.

Moreover, drink product vending machines for drinking water, tea, juice, etc. are widespread, and these vending machines display dummy display items of products for sale. As such dummy display items, a flat support that is formed by subjecting a transparent thermoplastic resin sheet to decorative printing is deep drawn to give a halved shape of an actual-size drink product container, thus forming a deep-drawn molding with a rise of 25 mm or higher in some cases, and the back face is illuminated so as to give a strong appeal to the product image.

As a process for producing a deep-draw molding from such a decorative thermoplastic resin sheet, vacuum forming, pressure forming, or vacuum/pressure forming is most suitable. In principle, vacuum forming involves preheating a flat support to a temperature at which it can be thermally deformed, and pressing and cooling it against a mold while drawing it to the mold by means of reduced pressure, and pressure forming involves pressing and cooling it against a mold while applying pressure from the side opposite to the mold. Vacuum/pressure forming involves carrying out the reduction in pressure and the application of pressure at the same time.

Therefore, in embossing, vacuum forming, pressure forming, and vacuum/pressure forming (hereinafter, called ‘vacuum forming, etc.’), since a thermoplastic resin sheet used as a substrate is required to have a high degree of stretchability in a heated state, a polycarbonate resin sheet, a polyester resin sheet, a cured vinyl chloride resin sheet, a polystyrene resin sheet, etc. are generally used, and from the viewpoint of ease of decorative printing and various resistance properties of a molding formed by vacuum forming, etc. being excellent, a polycarbonate resin sheet or a polyester resin sheet, and in particular a polycarbonate resin sheet, is most suitably used. As the thermoplastic resin sheet, one having a thickness of on the order of 0.1 to 0.8 mm, and preferably on the order of 0.3 to 0.6 mm, is generally used.

Furthermore, for decorating the above sheet a solvent-based ink containing a colorant such as a pigment as an ink and, as a binder, a vinyl chloride copolymer, a solvent-soluble polyester resin, an acrylic resin, etc. is normally used. A decorative printed layer that has been printed using such an ink is very suitably used since it exhibits good stretchability in vacuum forming, etc. by conforming to the substrate sheet in a heated state.

However, in the above-mentioned conventional method, since a solvent-based ink is used, there is the environmental problem that the solvent must be removed by evaporation, and there is the difficulty that thermal energy and drying time for removing the solvent by evaporation are required.

From such a viewpoint, printing a thermoplastic resin sheet using a UV-curing ink, which does not employ a solvent, and then processing it has been proposed (Japanese Patent No. 3119282). However, this proposal relates to cold bending, or to pressing or thermal pressing in which the rise angle is as small as on the order of 45° and the draw depth is as small as on the order of only 5 mm, and no attempt has been made to use a UV-curing colored ink for decorating a deep-drawn vacuum-formed product in which the sheet is drawn by a factor of several times.

Conventionally, as a printing method for obtaining a printed sheet (decorative sheet) to which molding, for example, vacuum forming, etc., is applied, a printing method employing a printing plate such as offset printing, screen printing, or gravure printing is used. These printing methods require an expensive printing system and preparation of a printing plate, and are not suitable for small-scale production because of the cost and effort.

On the other hand, in the inkjet method, the printing system is inexpensive, and no plate is required for printing; since an image is formed directly on a recording medium by discharging ink only onto a required image area, the ink can be used efficiently, and the running cost is low, particularly in small lot production. Moreover, the inkjet method has attracted attention in recent years since noise is low and it is excellent as an image recording method.

In particular, with regard to an inkjet recording ink that can be cured by irradiation with radiation such as ultraviolet rays (radiation curing type inkjet recording ink), since a majority of the ink component is cured by irradiation with radiation such as ultraviolet rays, the drying properties are excellent compared with a solvent-based ink and, furthermore, since an image obtained is resistant to spreading, the method can be applied to the printing of various types of substrate.

There is a demand for a radiation curing type ink composition that cures with high sensitivity in order to form a high quality image. By achieving higher sensitivity for the ink composition, high curability upon exposure to actinic radiation can be imparted, and there are therefore provided various benefits such as a reduction in power consumption, longer lifetime of an actinic radiation generator due to a decrease in the load thereon, and suppression of evaporation of uncured low molecular weight material and of a reduction in the strength of an image formed.

Furthermore, there is a desire for an ink composition that gives an image (printed material) that is resistant to cracking, peeling off, etc., and gives a cured film that has excellent impact resistance, flexibility, and adhesion to a substrate. A cured film having high flexibility, impact resistance, and adhesion to a substrate enables a printed material to be displayed or stored for a long period of time in various environments while maintaining high image quality, and also has advantages such as ease of handling of the printed material.

An ink composition used for obtaining a molded printed sheet (decorative sheet) is required to have a high level of cured film flexibility since an ink coating is stretched during molding. Furthermore, it is necessary for the cured film to have a strength that can withstand molding. Conventionally, ink compositions having high flexibility have been disclosed (International Patent Applications WO 2002/038688 and WO 2005/026270), but they have the problems that the film strength is insufficient, scratches or pinholes are caused on an image during molding, and cracks occur due to poor resistance to stretching.

Moreover, an ink that can be used in vacuum forming or pressure forming and can be cured by irradiation with radiation such as ultraviolet rays has been disclosed (JP-A-2003-326591 (JP-A denotes a Japanese unexamined patent application publication), but it has high viscosity and cannot be applied to the inkjet method.

### BRIEF SUMMARY OF THE INVENTION

It is an object of the present invention to provide a process for producing a molded printed material in which cracks and image dropouts are not generated when carrying out molding such as embossing, vacuum forming, pressure forming, or vacuum/pressure forming, and a molded printed material obtained by the process for producing a molded printed material.

These objects have been accomplished by means described in (1) and (10) below. They are described below together with (2) to (9), which are preferred embodiments. (1) A process for producing a molded printed material comprising (A) a step of forming an image by discharging an ink composition on a support by an inkjet method, the ink composition comprising at least one compound of monofunctional cationically polymerizable monomer selected from the group consisting of an oxetane compound, an oxirane compound, and a vinyl ether compound, and the proportion of the monofunctional cationically polymerizable monomer in the entire ink composition being at least 30 wt %, (B) a step of curing the ink composition by irradiating with actinic radiation the image obtained so as to obtain a printed material having the image cured on the support, and (C) a step of molding the printed material,
(2) the process for producing a molded printed material according to (1), wherein the monofunctional cationically polymerizable monomer is a cyclic structure-containing monomer,
(3) the process for producing a molded printed material according to (2), wherein the proportion of the cyclic structure-containing monofunctional cationically polymerizable monomer in the entire ink composition is at least 25 wt % but no greater than 80 wt %,
(4) the process for producing a molded printed material according to (2), wherein the cyclic structure-containing monofunctional cationically polymerizable monomer is a monofunctional oxetane compound,
(5) the process for producing a molded printed material according to any one of (1) to (4), wherein the monofunctional cationically polymerizable monomer comprises a low-polarity monofunctional oxetane compound and/or a low-polarity monofunctional oxirane compound,
(6) the process for producing a molded printed material according to any one of (1) to (5), wherein the ink composition comprises a polyfunctional oxetane compound and/or a polyfunctional oxirane compound, the total amount of the polyfunctional oxetane compound and/or polyfunctional oxirane compound being less than 25 wt % of the entire ink composition,
(7) the process for producing a molded printed material according to any one of (1) to (6), wherein the ink composition comprises the polyfunctional oxetane compound, the total amount of the oxetane compound being less than 15 wt % of the entire ink composition,
(8) the process for producing a molded printed material according to any one of (1) to (7), wherein the ink composition comprises a polyfunctional oxetane compound and a polyfunctional oxirane compound,
(9) the process for producing a molded printed material according to any one of (1) to (8), wherein the molding is embossing, vacuum forming, pressure forming, or vacuum/pressure forming, and
(10) a molded printed material obtained by the process for producing a molded printed material according to any one of (1) to (9).

### BRIEF DESCRIPTION OF DRAWINGS

FIG. 1 A schematic drawing of a projecting mold and a recessed mold used in the embossing test.

FIG. 2 A schematic drawing of a mold used in the vacuum forming test.

### DETAILED DESCRIPTION OF THE INVENTION

The process for producing a molded printed material of the present invention comprises (A) a step of forming an image by discharging an ink composition on a support by an inkjet method, the ink composition comprising at least one compound of monofunctional cationically polymerizable monomer selected from the group consisting of an oxetane compound, an oxirane compound, and a vinyl ether compound, and the proportion of the monofunctional cationically polymerizable monomer in the entire ink composition being at least 30 wt %, (B) a step of curing the ink composition by irradiating with actinic radiation the image obtained so as to obtain a printed material having the image cured on the support, and (C) a step of molding the printed material.

The present invention is explained in detail below.

### Ink Composition

The ink composition that can be used in the present invention (in the present invention, the ‘ink composition’ being also simply called an ‘ink’) is an ink composition that can be cured by radiation and that comprises at least one compound of monofunctional cationically polymerizable monomer selected from the group consisting of an oxetane compound, an oxirane compound, and a vinyl ether compound, the proportion of the monofunctional cationically polymerizable monomer in the entire ink composition being at least 30 wt %. It may comprise as necessary a cationic polymerization initiator, a colorant, a sensitizer, a cosensitizer, a polymerizable compound other than the above-mentioned monofunctional cationically polymerizable monomer, a polymerization initiator other than the above-mentioned cationic polymerization initiator, etc.

The ‘actinic radiation’ referred to in the present invention is not particularly limited as long as it is actinic radiation that can provide energy that enables an initiating species to be generated in the ink composition when irradiated, and broadly includes α rays, γ rays, X rays, ultraviolet rays, visible light, and an electron beam; among these, ultraviolet rays and an electron beam are preferable from the viewpoint of curing sensitivity and the availability of equipment, and ultraviolet rays are more preferable. The ink composition of the present invention is therefore preferably one that can cure upon exposure to ultraviolet rays.

When a specific moiety is called a ‘group’ in the present invention, it may be unsubstituted or substituted with at least one type of substituent (up to the maximum possible number) unless otherwise specified. For example, an ‘alkyl group’ means a substituted or unsubstituted alkyl group.

When a specific moiety is called a ‘ring’ in the present invention or the ‘group’ contains a ‘ring’, it may be a monocycle or a polycycle and may be substituted or unsubstituted unless otherwise specified. For example, an ‘aryl group’ may be a phenyl group or a naphthyl group, or a substituted phenyl group.

In the present invention, an oxetane compound and an oxirane compound are also called a ‘cyclic ether compound’ as a general name.

### Monofunctional Oxetane Compound and Monofunctional Oxirane Compound

In the present invention, a monofunctional cationically polymerizable monomer having only one oxetane group is also called a monofunctional oxetane compound, and a monofunctional cationically polymerizable monomer having only one oxirane group is also called a monofunctional oxirane compound.

The ink composition used in the present invention may employ a high-polarity monofunctional oxetane compound and/or a high-polarity monofunctional oxirane compound (hereinafter, also called simply a ‘high-polarity monofunctional cyclic ether compound’).

The high-polarity monofunctional cyclic ether compound referred to here is a high-polarity monofunctional cyclic ether compound having high polarity, that is, a high-polarity monofunctional cyclic ether compound having a high-polarity group in the molecule. In the present invention, the ink composition can achieve good dispersibility by containing the high-polarity monofunctional cyclic ether compound.

With regard to the high-polarity monofunctional cyclic ether compound, one compound thereof may be used on its own, or two or more compounds thereof may be used in combination. It is also possible to use only the high-polarity monofunctional oxetane compound, or only the high-polarity monofunctional oxirane compound, or the two compounds in combination.

Examples of the high-polarity monofunctional cyclic ether compound used in the present invention include a compound having a molecular log P value (octanol/water partition coefficient) of less than 1.0, and examples of a low-polarity monofunctional cyclic ether compound include a compound having a molecular log P value of 1.0 or greater.

The high-polarity group referred to in the present invention means a functional group containing a high-polarity group such as an ester bond, a carbonate bond, a hydroxyl group, an optionally substituted amino group, urethane bond, amide bond, urea bond, bisphenoxy bond, nitrogen-containing cyclic compound group, or oxygen-containing cyclic compound group, an alkylene glycol structure, etc.

Examples of the alkylene glycol structure include alkylene glycol chains such as an ethylene glycol chain, a propylene glycol chain, and a tetraethylene glycol chain, and polyalkylene glycol chains such as a polyethylene glycol chain, a polypropylene glycol chain, and a polytetraethylene glycol chain.

The high-polarity monofunctional oxetane compound and the high-polarity monofunctional oxirane compound have one cyclic ether structure. From the viewpoint of reactivity and availability, specific preferred examples thereof include the structures below. A portion shown by a wavy line is the position of bonding to another structure.

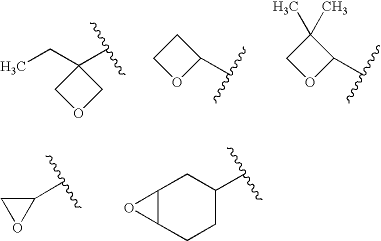

The cyclic ether structure in the high-polarity monofunctional cyclic ether compound may further have a substituent on the ether ring if it can be introduced.

Examples of the substituent include an alkyl group, a cycloalkyl group, an aryl group, a halogen atom, an alkoxy group, an aryloxy group, a nitro group, and an amino group. These substituents may be further substituted with the above-mentioned substituent if this is possible. Two substituents may be bonded to form a ring structure, or may form a ring structure by bonding to a structural portion other than the cyclic ether structure.

The high-polarity monofunctional cyclic ether compound that can be used in the present invention may have one each of a partial structure containing the cyclic ether and a partial structure represented by Formula (I) below in its molecular structure.

—X¹—R¹ (I)

In Formula (I), X¹ denotes a single bond, an optionally branched alkylene group having 5 or less carbons, an ether bond, an ester bond, a carbonate bond, a urethane bond, an amide bond, a urea bond, a bisphenoxy bond, an alkylene glycol structure-containing group, or a divalent linking group containing a high-polarity group in which two or more of these groups are combined.

The structure shown in Formula (I) is preferably linked to any carbon atom of the cyclic ether (oxetane ring or oxirane ring) via a linking group such as an alkylene group.

In the partial structure represented by Formula (I) above, R¹ denotes an alkyl group, an aromatic group such as a monocyclic aromatic group or a polycyclic aromatic group, an alicyclic hydrocarbon group having a structure selected from the group consisting of a cycloalkane skeleton, an adamantane skeleton, and a norbornane skeleton, or a group in which two or more of these groups are combined. The cyclic structure of the above-mentioned aromatic group and alicyclic hydrocarbon group may contain a heteroatom such as O, N, or S.

The alkyl group denoted by R¹ is preferably an alkyl group having 2 to 12 carbon atoms, more preferably 2 to 8 carbon atoms, and yet more preferably 2 to 6 carbon atoms. Specific preferred examples thereof include an ethyl group, a propyl group, an isopropyl group, a butyl group, a pentyl group, and a hexyl group.

The cycloalkane skeleton-containing group denoted by R¹ is preferably a cycloalkane having 4 to 12 carbon atoms, more preferably 4 to 8 carbon atoms, and yet more preferably 5 to 7 carbon atoms. Specific preferred examples thereof include a cycloheptyl group, a cyclohexyl group, a cyclopentyl group, a bicyclic ring group, an adamantyl group, and a norbornyl group.

The aromatic group denoted by R¹ is preferably an aromatic group having 6 to 18 carbon atoms, more preferably 6 to 12 carbon atoms, and yet more preferably 6 to 8 carbon atoms. Specific preferred examples thereof include groups such as a phenyl group, a biphenyl group, and a naphthyl group, and a phenyl group is more preferable. R¹ may be a group in which two or more of these groups are combined, and a benzyl group is more preferable.

R¹ may have a substituent.

Examples of the substituent include a halogen atom, an alkoxy group, an aryloxy group, a nitro group, and an amino group.

R¹ is particularly preferably an unsubstituted alkyl group, an unsubstituted cycloalkyl group, or an unsubstituted aryl group.

The total number of oxygen atoms in the high-polarity monofunctional cyclic ether compound is preferably at least 3, and more preferably 3 to 7. It is preferable for the total number of oxygen atoms to be at least 3 since good dispersion stability can be given.

Specific examples of the high-polarity monofunctional cyclic ether compound that can preferably be used in the present invention (compound examples (1) to (60)) are listed below, but the present invention should not be construed as being limited thereto. In some of the compound examples below, a hydrocarbon chain is represented by a simplified structural formula in which symbols for carbon (C) and hydrogen (H) are omitted. Compounds described later may also be represented by simplified structural formulae.

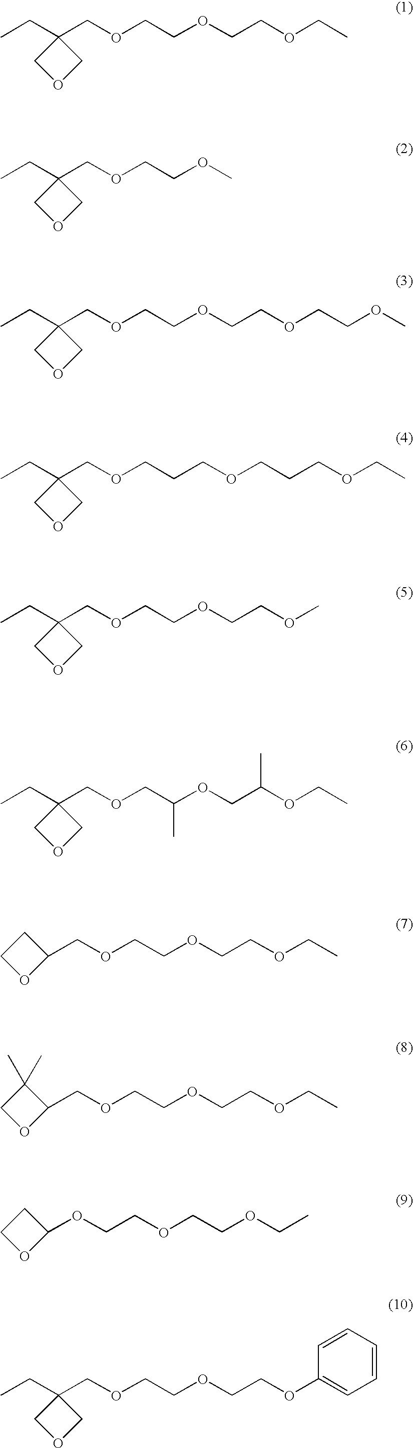

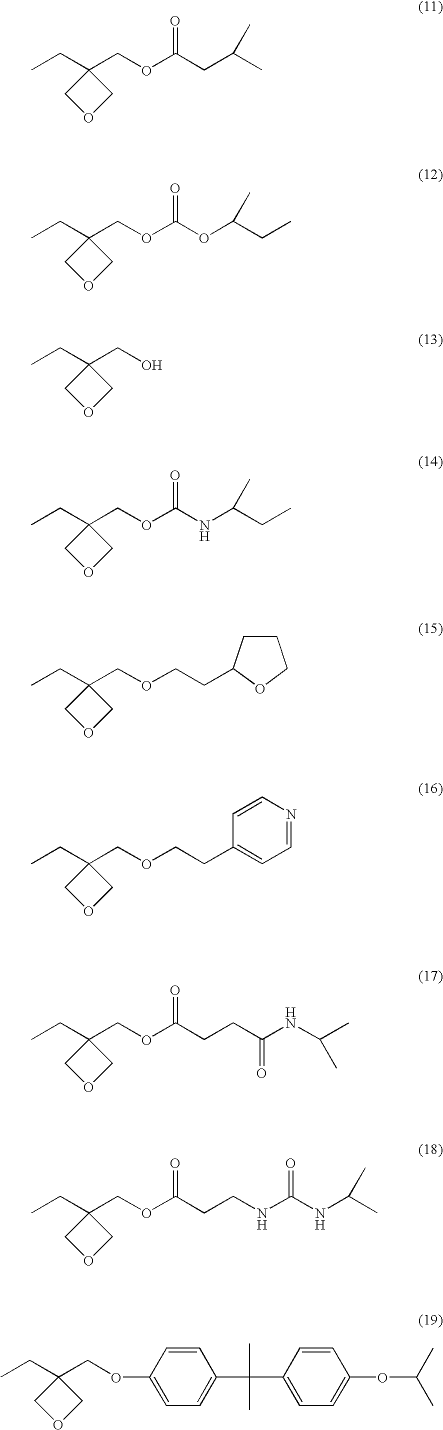

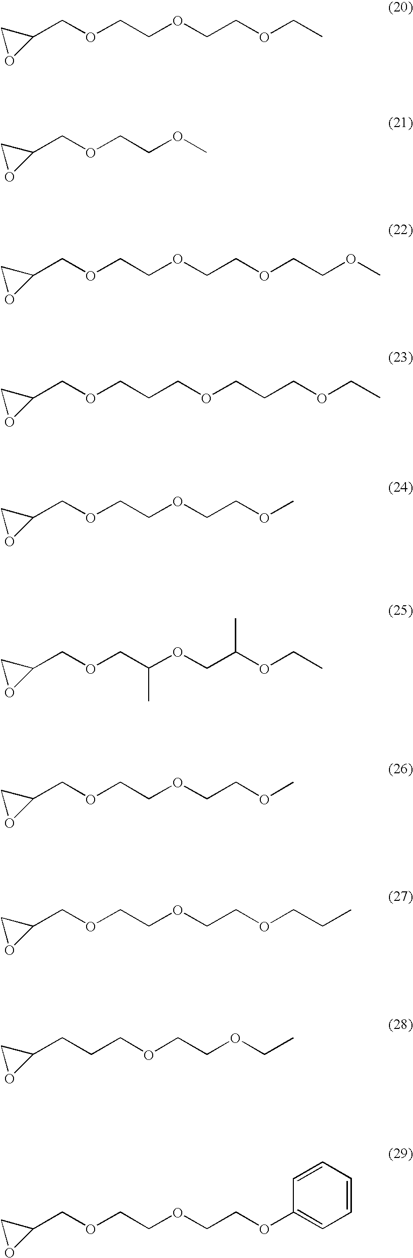

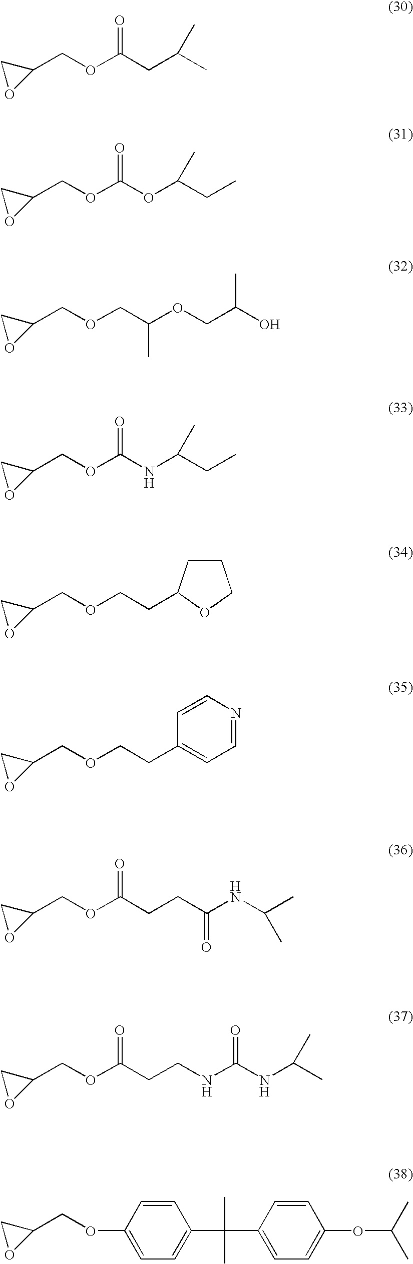

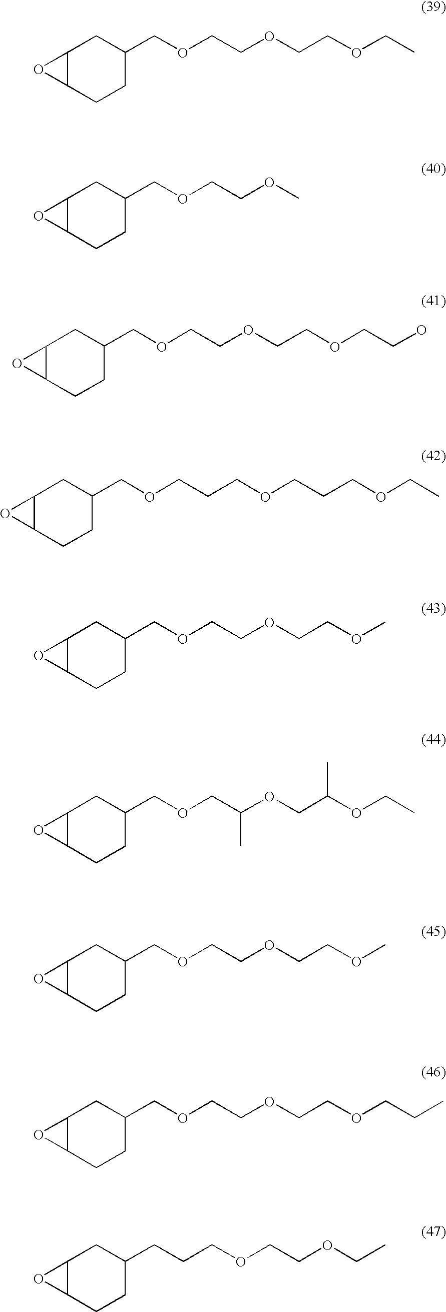

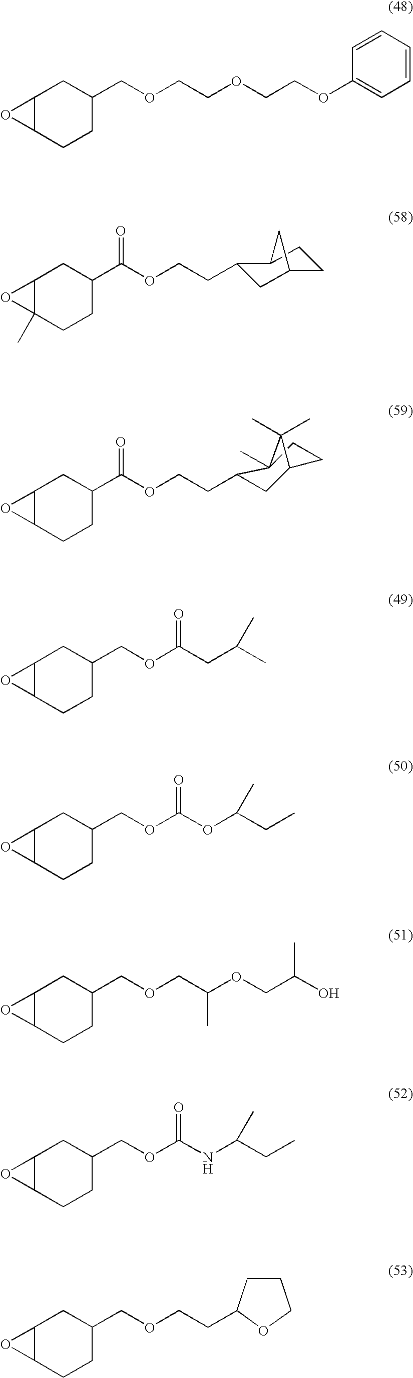

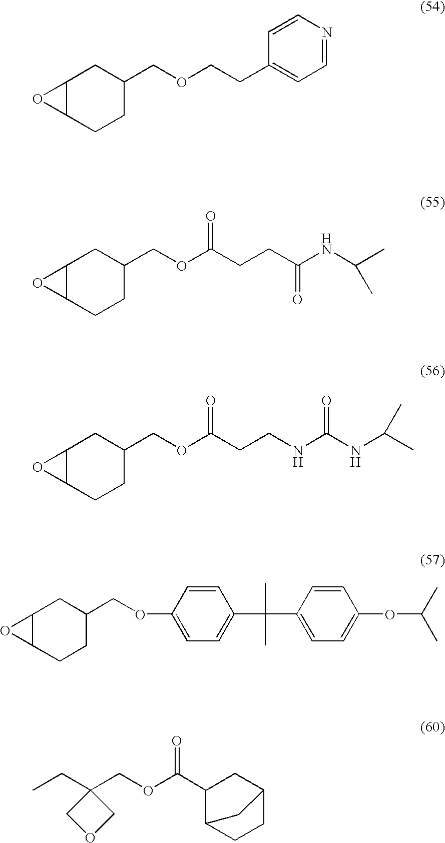

In the present invention, the ink composition may employ a low-polarity monofunctional oxetane compound and/or a low-polarity monofunctional oxirane compound (hereinafter, also called simply a ‘low-polarity monofunctional cyclic ether compound’).

The low-polarity monofunctional cyclic ether compound referred to here is a monofunctional oxetane or oxirane compound having low polarity, and more particularly an oxetane or oxirane compound having no high-polarity group in the molecule.

The low-polarity monofunctional cyclic ether compound that can be used in the present invention is preferably a compound in which the total number of oxygen atoms in the molecule is 1 or 2, and the molecular structure apart from the oxetane ring or the oxirane ring is formed from a hydrocarbon chain alone or a hydrocarbon chain and one ether bond.

The low-polarity monofunctional cyclic ether compound has one cyclic ether structure, and from the viewpoint of reactivity and availability preferred examples thereof are listed below.

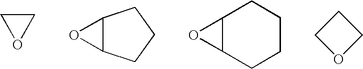

The cyclic ether structure may have a substituent if it can be introduced.

Examples of the substituent include an alkyl group, a cycloalkyl group, and an aryl group, and specific examples thereof include a methyl group, an ethyl group, and a phenyl group.

These substituents may be further substituted with the above-mentioned substituent if this is possible. Two or more substituents may be bonded to form a ring structure or may be bonded to a structural portion other than the cyclic ether structure to form a ring structure, and it may be for example a structure having the above-mentioned cyclic ether structure on an adamantane skeleton or a norbornane skeleton. However, a total of two or more of the oxetane structure and the oxirane structure are not formed in one molecule.

The low-polarity monofunctional cyclic ether compound that can be used in the present invention may have one each of a partial structure containing the above-mentioned cyclic ether and a partial structure represented by Formula (II) below in its molecular structure. The structure represented by Formula (II) is preferably bonded to any carbon atom in the cyclic ether via a linking group such as an alkylene group. One or more partial structures represented by Formula (II) may be contained in the low-polarity monofunctional oxetane compound or the low-polarity monofunctional oxirane compound.

—X²—R² (II)

In Formula (II), X² denotes a single bond, an ether bond, an optionally branched alkylene group having no greater than 20 carbons, or a divalent linking group in which they are combined. When X² contains an ether bond, only one ether bond is contained in Formula (II).

In Formula (II), R² denotes an alkyl group, an alicyclic hydrocarbon group containing a structure selected from the group consisting of a cycloalkane skeleton, an adamantane skeleton, and a norbornane skeleton, or an aromatic group containing a structure selected from the group consisting of a monocyclic aromatic group and a polycyclic aromatic group, and in the present invention it is preferably an optionally substituted alkyl group having at least 1 carbon, an optionally substituted alicyclic hydrocarbon group having at least 4 carbons, or an optionally substituted aromatic group.

Examples of the alkyl group denoted by R² include an optionally substituted alkyl group having at least 1 carbon. It is also preferable for the number of carbons to be no greater than 30. Specific examples thereof include a methyl group, an ethyl group, an n-propyl group, an isopropyl group, a butyl group, an isobutyl group, a tertiary butyl group, a pentyl group, a neopentyl group, an n-hexyl group, an n-heptyl group, an n-octyl group, a 2-ethylhexyl group, an n-nonyl group, an n-decyl group, an n-dodecyl group, an n-tridecyl group, and an n-stearyl group.

Examples of the alicyclic hydrocarbon group denoted by R² include an optionally substituted alicyclic hydrocarbon group having at least 4 carbons. It is also preferable for the number of carbons to be no greater than 30. Specific examples thereof include a cycloheptyl group, a cyclohexyl group, a cyclopentyl group, a bicyclic ring group, an adamantyl group, and a norbornyl group.

The aromatic group denoted by R² is preferably an optionally substituted aromatic group having 6 to 18 carbon atoms, more preferably 6 to 12 carbon atoms, and yet more preferably 6 to 8 carbon atoms. Specific examples thereof include a phenyl group, a biphenyl group, a naphthyl group, and a p-nonylphenyl group.

Specific preferred examples of the low-polarity monofunctional oxetane compound or the low-polarity monofunctional oxirane compound that can be used in the present invention (compound examples (1) to (63)) are listed below, but the present invention should not be construed as being limited thereto.

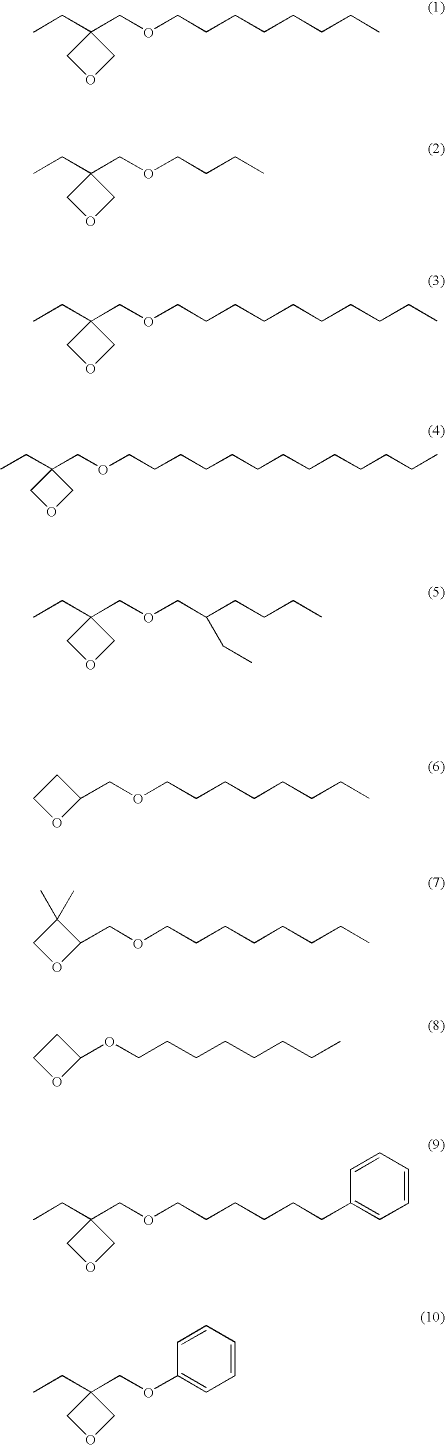

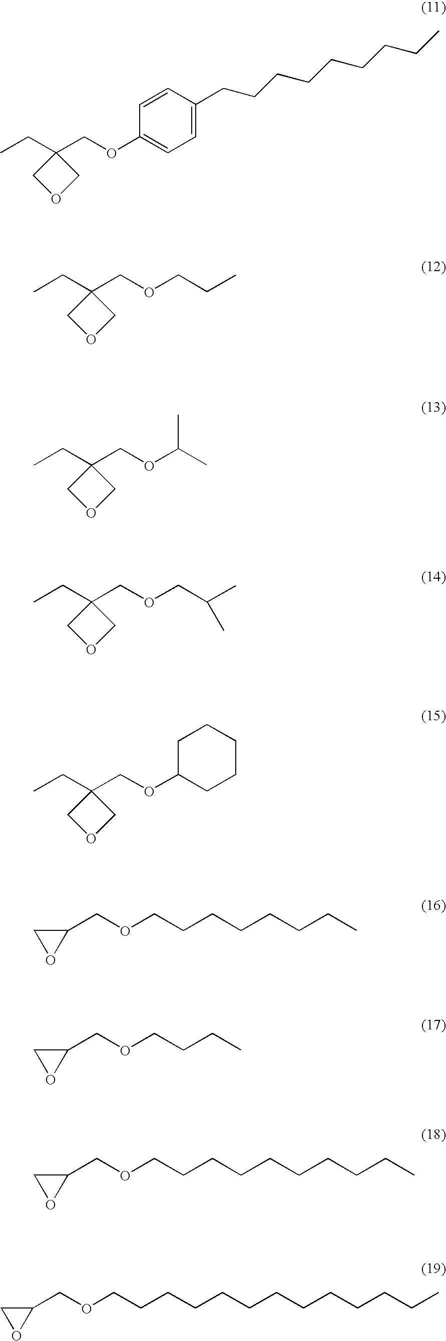

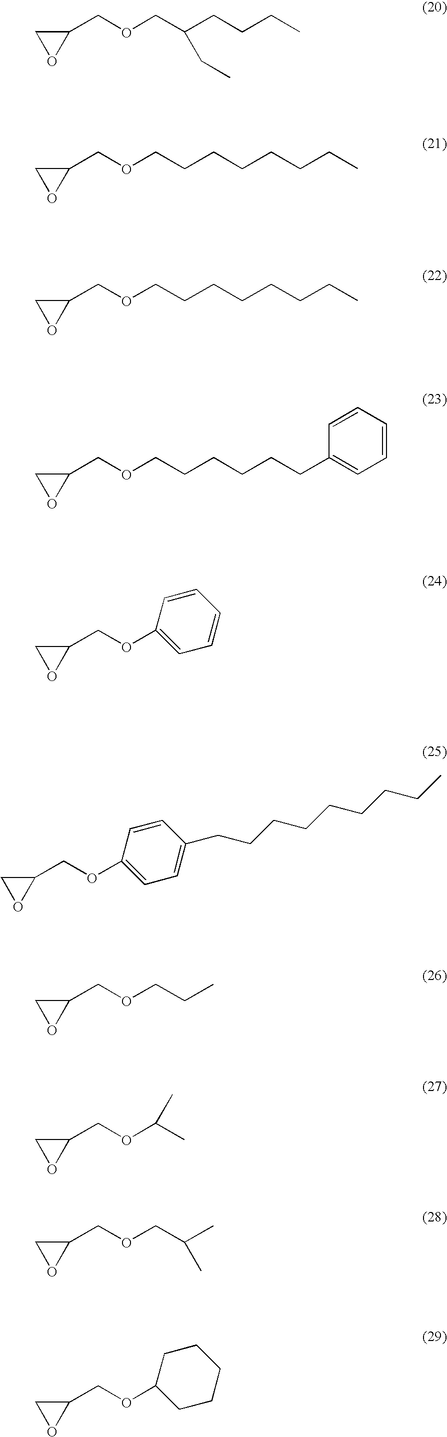

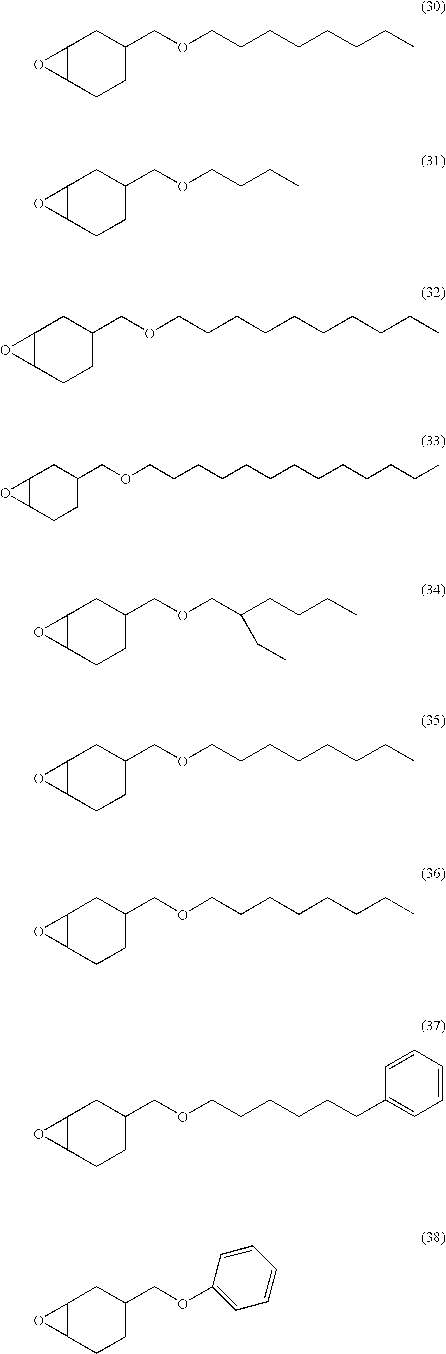

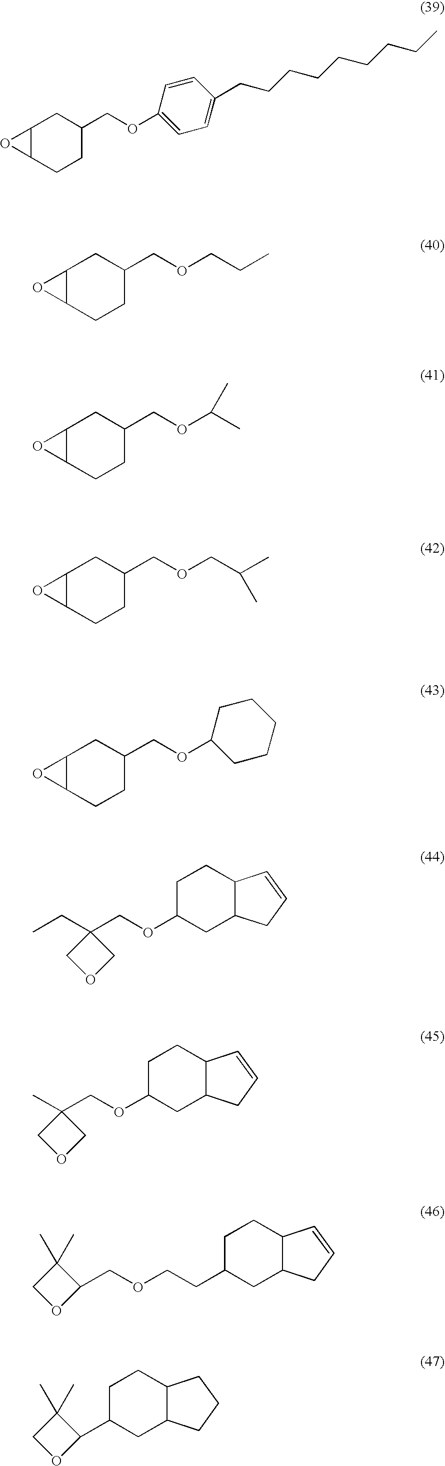

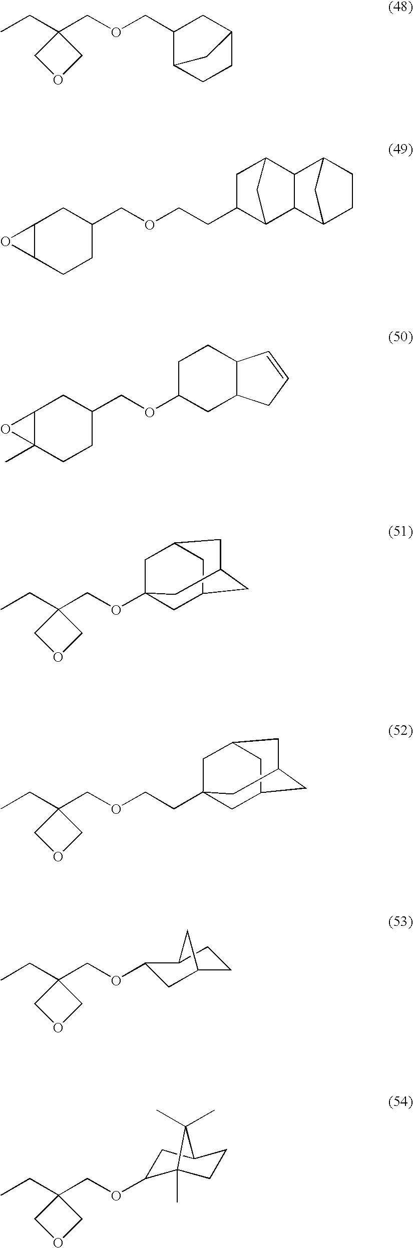

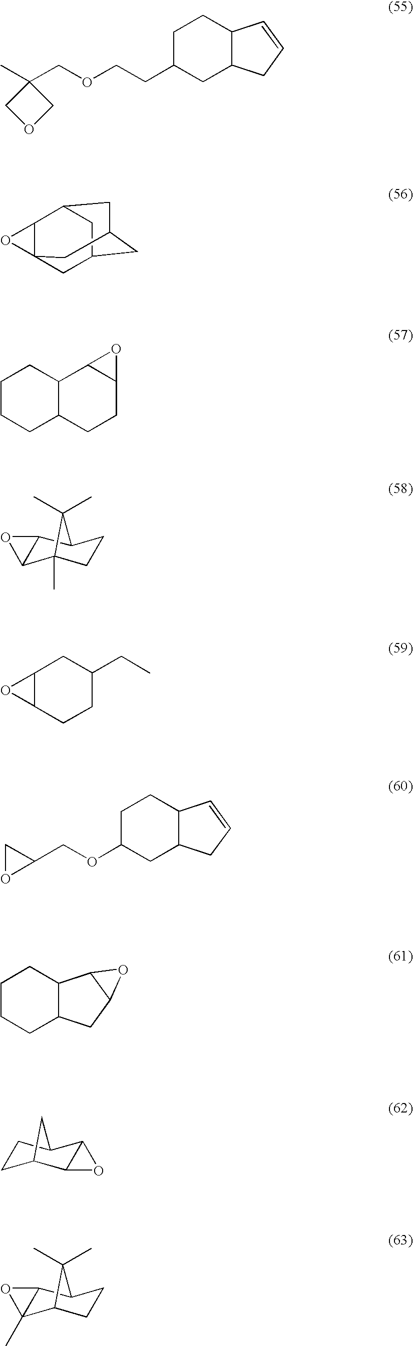

In the present invention, it is preferable to use the low-polarity monofunctional cyclic ether compound, and among compounds (1) to (63) above, monofunctional monomers (5), (10), (15), and (44) to (59) are more preferably used.

In the present invention, the ratio of the high-polarity monofunctional cyclic ether compound to the low-polarity monofunctional cyclic ether compound used may be any ratio and may be selected as appropriate while taking into consideration the dispersion properties of the ink composition, etc. As described above, in the present invention the low-polarity monofunctional cyclic ether compound can preferably be used.

In the present invention, it is preferable to use a cyclic structure-containing monofunctional cationically polymerizable monomer. That is, as a monofunctional cationically polymerizable monomer selected from the group consisting of an oxetane compound, an oxirane compound, and a vinyl ether compound, it is preferable to use a cyclic structure-containing monofunctional cationically polymerizable monomer. It is preferable to use a cyclic structure-containing monofunctional cationically polymerizable monomer since an ink composition can be provided that has excellent curability and gives a cured film having high mold release properties in a molding process and high abrasion resistance such as scratch resistance.

Examples of the cyclic structure include aromatic groups such as a monocyclic aromatic group and a polycyclic aromatic group, alicyclic hydrocarbon groups such as a monocyclic alicyclic hydrocarbon group and a polycyclic alicyclic hydrocarbon group, and a group in which two or more of these groups are combined. The cyclic structure of the aromatic group and the alicyclic hydrocarbon group above may contain a heteroatom such as O, N, or S. Furthermore, examples of the alicyclic hydrocarbon group include a cycloalkane skeleton, an adamantane skeleton, and a norbornane skeleton.

In the present invention, the cyclic structure-containing monofunctional cationically polymerizable monomer preferably contains an aromatic group, and is more preferably a monocyclic aromatic group-containing monomer. It is particularly preferably a phenyl group-containing monomer.

When it has an alicyclic hydrocarbon group, it preferably contains a polycyclic alicyclic hydrocarbon group. As the polycyclic alicyclic hydrocarbon group, an adamantane skeleton or a norbornane skeleton is preferable, and a norbornane skeleton is particularly preferable.

The proportion of the cyclic structure-containing monofunctional cationically polymerizable monomer in the entire ink composition is preferably at least 25 wt % but no greater than 80 wt %, and more preferably at least 40 wt % but no greater than 80 wt %.

In the present invention, the ink composition preferably contains a cyclic structure-containing monofunctional oxetane compound, the proportion of the cyclic structure-containing monofunctional oxetane compound in the entire ink composition being preferably at least 25 wt % but no greater than 80 wt %, and more preferably at least 40 wt % but no greater than 80 wt %.

### Polyfunctional Oxetane Compound and Polvfunctional Oxirane Compound

The ink composition that can be used in the present invention may contain a polyfunctional oxetane compound or a polyfunctional oxirane compound (hereinafter, also simply called a ‘polyfunctional cyclic ether compound’).

The polyfunctional oxetane compound referred to here is a compound having at least 2 oxetane rings in one molecule. In the present invention, one compound of polyfunctional oxetane compound may be used on its own, or two or more compounds thereof may be used in combination.

The polyfunctional oxetane compound has at least 2, preferably 2 to 6, and more preferably 2 to 4 oxetane rings in the molecule. It is preferable for the number of oxetane rings in the molecule to be in the above-mentioned range since good curability and flexibility of a cured film are obtained.

Examples of compounds having 2 oxetane rings in the molecule include compounds represented by Formulae (1) and (2) below.

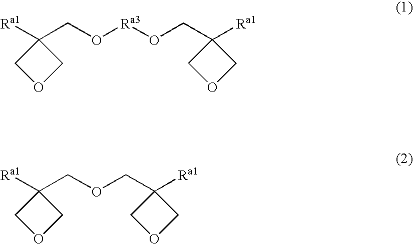

R^{a1} denotes a hydrogen atom, an alkyl group having 1 to 6 carbons, a fluoroalkyl group having 1 to 6 carbons, an allyl group, an aryl group, a furyl group, or a thienyl group. When there are two R^{a1} in the molecule, they may be identical to or different from each other.

Examples of the alkyl group include a methyl group, an ethyl group, a propyl group, and a butyl group, and preferred examples of the fluoroalkyl group include those obtained by substituting any of the hydrogen atoms of the above alkyl groups with a fluorine atom.

R^{a3} denotes a linear or branched alkylene group, a linear or branched poly(alkyleneoxy) group, a linear or branched unsaturated hydrocarbon group, a carbonyl group, a carbonyl group-containing alkylene group, a carboxyl group-containing alkylene group, a carbamoyl group-containing alkylene group, or a group shown below. Examples of the alkylene group include an ethylene group, a propylene group, and a butylene group, and examples of the poly(alkyleneoxy) group include a poly(ethyleneoxy) group and a poly(propyleneoxy) group. Examples of the unsaturated hydrocarbon group include a propenylene group, a methylpropenylene group, and a butenylene group.

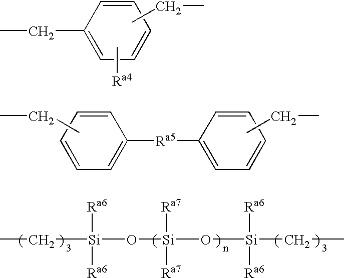

When R^{a3} is the above-mentioned polyvalent group, R^{a4} denotes a hydrogen atom, an alkyl group having 1 to 4 carbons, an alkoxy group having 1 to 4 carbons, a halogen atom, a nitro group, a cyano group, a mercapto group, a lower alkylcarboxyl group, a carboxyl group, or a carbamoyl group.

R^{a5} denotes an oxygen atom, a sulfur atom, a methylene group, NH, SO, SO₂, C(CF₃)₂, or C(CH₃)₂.

R^{a6} denotes an alkyl group having 1 to 4 carbons or an aryl group, and n is an integer of 0 to 2,000. R^{a7} denotes an alkyl group having 1 to 4 carbons, an aryl group, or a monovalent group having the structure below. In the formula, R^{a8} denotes an alkyl group having 1 to 4 carbons or an aryl group, and m is an integer of 0 to 100.

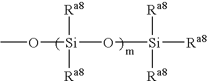

Examples of the compound represented by Formula (1) include 1,4-bis(3-ethyl-3-oxetanylmethoxy)methyl]benzene (OXT-121: Toagosei Co., Ltd.). Examples of the compound represented by Formula (2) include bis(3-ethyl-3-oxetanylmethyl) ether (OXT-221: Toagosei Co., Ltd.).

Examples of the compound having 3 to 4 oxetane rings in the molecule include compounds represented by Formula (3) below.

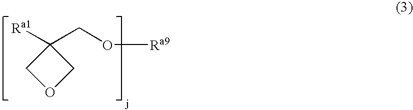

In Formula (3), R^{a1} denotes the same as in Formula (1) above. Furthermore, examples of R^{a9}, which is a polyvalent linking group, include a branched alkylene group having 1 to 12 carbons such as a group represented by A to C below, a branched poly(alkyleneoxy) group such as a group represented by D below, and a branched polysiloxane group such as a group represented by E below. j is 3 or 4.

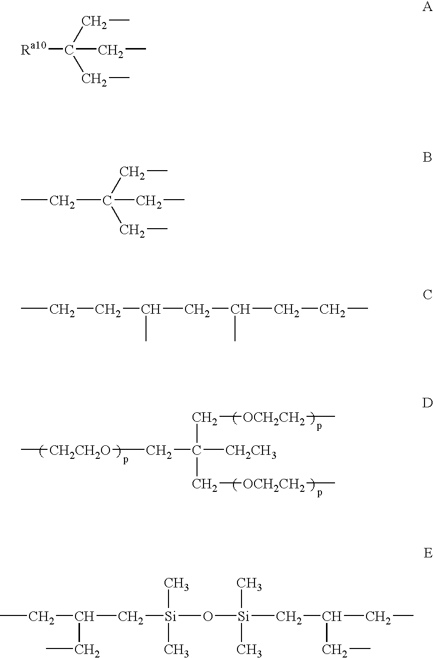

In the above A, R^{a10} denotes a methyl group, an ethyl group, or a propyl group. Furthermore, in the above D, p is an integer of 1 to 10.

Moreover, as another embodiment of the oxetane compound that can be suitably used in the present invention, a compound having an oxetane ring on a side chain, represented by Formula (4) below, can be cited.

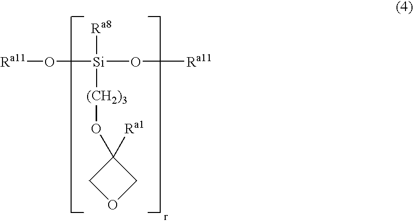

In Formula (4), R^{a1} and R^{a8} denote the same as in the above-mentioned formula. R^{a11} is an alkyl group having 1 to 4 carbons such as a methyl group, an ethyl group, a propyl group, or a butyl group, or a trialkylsilyl group, and r is 1 to 4.

Such compounds having an oxetane ring are described in detail in paragraph Nos. 0021 to 0084 of JP-A-2003-341217 above, and the compounds described here may be suitably used in the present invention. Furthermore, oxetane compounds described in JP-A-2004-91556 can also be used in the present invention. They are described in detail in Paragraph Nos. 0022 to 0058.

The polyfunctional oxirane compound referred to here is a compound having at least 2 oxirane rings in one molecule. In the present invention, one compound of polyfunctional oxirane compound may be used on its own, or two or more compounds thereof may be used in combination.

In the present invention, the polyfunctional oxirane compound has at least 2, preferably 2 to 6, and more preferably 2 to 4 oxirane rings in the molecule. It is preferable for the number of oxirane rings in the molecule to be in the above-mentioned range since good curability and good flexibility of a cured film are obtained.

Examples of the polyfunctional oxirane compound include a polyfunctional aromatic oxirane compound, a polyfunctional alicyclic oxirane compound, and a polyfunctional aliphatic oxirane compound; examples of the aromatic oxirane compound include a di- or poly-glycidyl ether produced by a reaction between epichlorohydrin and a polyhydric phenol having at least one aromatic nucleus or an alkylene oxide adduct thereof, and specific examples thereof include the di- or poly-glycidyl ether of bisphenol A or an alkylene oxide adduct thereof, the di- or poly-glycidyl ether of hydrogenated bisphenol A or an alkylene oxide adduct thereof, and a novolac epoxy resin. Examples of the alkylene oxide include ethylene oxide and propylene oxide.

Preferred examples of the polyfunctional alicyclic oxirane compound include a cyclohexene oxide- or cyclopentene oxide-containing compound obtained by epoxidizing a compound containing at least two cycloalkene rings such as cyclohexene rings or cyclopentene rings with an appropriate oxidizing agent such as hydrogen peroxide or a peracid. Examples thereof further include a cyclohexene dioxide- or cyclopentene dioxide-containing compound obtained by epoxidizing a compound having a cycloalkadiene ring such as a cyclohexadiene ring or a cyclopentadiene ring.

Examples of the polyfunctional aliphatic oxirane compound include di- or polyglycidyl ethers of an aliphatic polyhydric alcohol or an alkylene oxide adduct thereof, and representative examples thereof include diglycidyl ethers of an alkylene glycol such as the diglycidyl ether of ethylene glycol, the diglycidyl ether of propylene glycol, and the diglycidyl ether of 1,6-hexanediol, polyglycidyl ethers of a polyhydric alcohol such as the di- or triglycidyl ether of glycerol or an alkylene oxide adduct thereof, and diglycidyl ethers of a polyalkylene glycol such as the diglycidyl ether of polyethylene glycol or an alkylene oxide adduct thereof and the diglycidyl ether of polypropylene glycol or an alkylene oxide adduct thereof. Examples of the alkylene oxide above include ethylene oxide and propylene oxide.

Detailed examples of polyfunctional oxirane compounds that can be used in the present invention are now given.

Examples of polyfunctional oxirane compounds include bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolac resins, hydrogenated bisphenol A diglycidyl ether, hydrogenated bisphenol F diglycidyl ether, hydrogenated bisphenol S diglycidyl ether, 3,4-epoxycyclohexenylmethyl-3′,4′-epoxycyclohexenecarboxylate, 2-(3,4-epoxycyclohexyl-5,5-spiro-3,4-epoxy)cyclohexane-meta-dioxane, bis(3,4-epoxycyclohexylmethyl) adipate, vinylcyclohexene dioxide, 4-vinylepoxycyclohexane, bis(3,4-epoxy-6-methylcyclohexylmethyl) adipate, 3,4-epoxy-6-methylcyclohexenyl 3′,4′-epoxy-6′-methylcyclohexenecarboxylate, methylenebis(3,4-epoxycyclohexane), dicyclopentadiene diepoxide, the di(3,4-epoxycyclohexylmethyl) ether of ethylene glycol, ethylene bis(3,4-epoxycyclohexanecarboxylate), dioctyl epoxyhexahydrophthalate, di-2-ethylhexyl epoxyhexahydrophthalate, 1,4-butanediol diglycidyl ether, 1,6-hexanediol diglycidyl ether, glycerol triglycidyl ether, trimethylolpropane triglycidyl ether, polyethylene glycol diglycidyl ether, polypropylene glycol diglycidyl ether, 1,13-tetradecadiene dioxide, limonene dioxide, 1,2,7,8-diepoxyoctane, and 1,2,5,6-diepoxycyclooctane.

Among these polyfunctional oxirane compounds, the polyfunctional aromatic oxirane compounds and the polyfunctional alicyclic oxirane compounds are preferable from the viewpoint of excellent curing speed, and the polyfunctional alicyclic oxirane compounds are particularly preferable.

In the present invention, it is preferable for the ink composition to comprise an oxetane compound and an oxirane compound, and it is more preferable for it to comprise a polyfunctional oxirane compound and a polyfunctional oxetane compound. Making an oxetane compound and an oxirane compound coexist in the composition enables an ink composition to be provided that has excellent curability and gives a cured film having high release properties from a mold during a molding process and high abrasion resistance such as scratch resistance. It is more preferable for a polyfunctional oxetane compound and a polyfunctional oxirane compound to coexist.

In the present invention, the total proportion of the polyfunctional oxetane compound and the polyfunctional oxirane compound in the entire ink is preferably less than 25 wt %. It is preferable for the proportion to be less than 25 wt % since an ink composition giving a cured film having excellent stretchability can be provided.

### Monofunctional Vinyl Ether Compound

The ink composition that can be used in the present invention may comprise the monofunctional vinyl ether compound as the monofunctional cationically polymerizable monomer. Examples of the monofunctional vinyl ether compounds that can be used in the present invention include monovinyl ether compounds such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexanedimethanol monovinyl ether, n-propyl vinyl ether, isopropyl vinyl ether, isopropenyl vinyl ether, dodecyl vinyl ether, and diethylene glycol monovinyl ether.

Detailed examples of monofunctional vinyl ether compounds are now given.

Specific examples of monofunctional vinyl ethers include methyl vinyl ether, ethyl vinyl ether, propyl vinyl ether, n-butyl vinyl ether, t-butyl vinyl ether, 2-ethylhexyl vinyl ether, n-nonyl vinyl ether, lauryl vinyl ether, cyclohexyl vinyl ether, cyclohexylmethyl vinyl ether, cyclohexanedimethanol monovinyl ether, 4-methylcyclohexylmethyl vinyl ether, benzyl vinyl ether, dicyclopentenyl vinyl ether, 2-dicyclopentenoxyethyl vinyl ether, methoxyethyl vinyl ether, ethoxyethyl vinyl ether, butoxyethyl vinyl ether, methoxyethoxyethyl vinyl ether, ethoxyethoxyethyl vinyl ether, methoxypolyethylene glycol vinyl ether, tetrahydrofurfuryl vinyl ether, 2-hydroxyethyl vinyl ether, 2-hydroxypropyl vinyl ether, 4-hydroxybutyl vinyl ether, 4-hydroxymethylcyclohexylmethyl vinyl ether, diethylene glycol monovinyl ether, polyethylene glycol vinyl ether, chloroethyl vinyl ether, chlorobutyl vinyl ether, chloroethoxyethyl vinyl ether, phenylethyl vinyl ether, and phenoxypolyethylene glycol vinyl ether, and among these cyclohexanedimethanol monovinyl ether is preferable

### Polyfunctional Vinyl Ether Compound

The ink composition that can be used in the present invention may comprise polyfunctional vinyl ether compound. Examples of the polyfunctional vinyl ether compounds include ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexanedimethanol divinyl ether, and trimethylolpropane trivinyl ether,

Detailed examples of polyfunctional vinyl ether compounds are now given.

Examples of polyfunctional vinyl ethers include divinyl ethers such as ethylene glycol divinyl ether, diethylene glycol divinyl ether, polyethylene glycol divinyl ether, propylene glycol divinyl ether, butylene glycol divinyl ether, hexanediol divinyl ether, bisphenol A alkylene oxide divinyl ether, and bisphenol F alkylene oxide divinyl ether; and polyfunctional vinyl ethers such as trimethylolethane trivinyl ether, trimethylolpropane trivinyl ether, ditrimethylolpropane tetravinyl ether, glycerol trivinyl ether, pentaerythritol tetravinyl ether, dipentaerythritol pentavinyl ether, dipentaerythritol hexavinyl ether, an ethylene oxide adduct of trimethylolpropane trivinyl ether, a propylene oxide adduct of trimethylolpropane trivinyl ether, an ethylene oxide adduct of ditrimethylolpropane tetravinyl ether, a propylene oxide adduct of ditrimethylolpropane tetravinyl ether, an ethylene oxide adduct of pentaerythritol tetravinyl ether, a propylene oxide adduct of pentaerythritol tetravinyl ether, an ethylene oxide adduct of dipentaerythritol hexavinyl ether, and a propylene oxide adduct of dipentaerythritol hexavinyl ether, and among these triethylene glycol divinyl ether is preferable.

As the vinyl ether compound, the di- or tri-vinyl ether compounds are preferable from the viewpoint of curability, adhesion to a recording medium, surface hardness of the image formed, etc., and the divinyl ether compounds are particularly preferable.

In the present invention, the content of the monofunctional cationically polymerizable monomer selected from the group consisting of an oxetane compound, an oxirane compound, and a vinyl ether compound is at least 30 wt % relative to the entire ink composition, preferably 40 to 80 wt %, and particularly preferably 50 to 70 wt %. When the value is in the above-mentioned range, it is possible to provide an ink composition having excellent curability and giving a cured film having excellent stretchability when molding.

Among the monofunctional cationically polymerizable monomers, it is preferable for at least one compound of monofunctional oxirane compound or monofunctional oxetane compound to be contained, and it is particularly preferable for at least one compound of monofunctional oxetane compound to be contained. Among the monofunctional monomers, a monomer having an aromatic group, an alicyclic hydrocarbon group, or a cyclic structure containing a heteroatom such as N, S, or O is preferable.

The ink composition that can be used in the present invention preferably comprises a polyfunctional oxetane compound and/or a polyfunctional oxirane compound, the total amount of the polyfunctional oxetane compound and/or the polyfunctional oxirane compound being less than 25 wt % of the entire ink composition. Furthermore, the ink composition more preferably comprises a polyfunctional oxetane compound, the total amount of the polyfunctional oxetane compound being less than 15 wt % of the entire ink composition.

It is preferable for the value to be in the above-mentioned range since an ink composition having excellent curability and giving a cured film having excellent stretchability can be provided.

### Cationic Polymerization Initiator

The ink composition that can be used in the present invention preferably contains a cationic polymerization initiator. As the cationic polymerization initiator (photo-acid generator) that can be used in the present invention, for example, compounds that are used for chemically amplified photoresists or cationic photopolymerization are used (ref. ‘Imejingu yo Yukizairyou’ (Organic Materials for Imaging) Ed. The Japanese Research Association for Organic Electronics Materials, Bunshin Publishing Co. (1993), pp. 187-192). Examples of the cationic polymerization initiator suitably used in the present invention are listed below.

Firstly, B(C₆F₅)₄⁻, PF₆⁻, AsF₆⁻, SbF₆⁻, and CF₃SO₃⁻ salts of aromatic onium compounds such as diazonium, ammonium, iodonium, sulfonium, and phosphonium can be cited. Secondly, sulfonates that generate a sulfonic acid can be cited. Thirdly, halides that photogenerate a hydrogen halide can also be used. Fourthly, iron allene complexes can be cited.

In the present invention, the cationic polymerization initiator that can be used in the ink composition may be used on its own or in a combination of two or more types. The cationic polymerization initiator may preferably be used in a range of 0.01 to 20 parts by weight relative to 100 parts by weight of the cationically polymerizable compound, and more preferably 0.5 to 10 parts by weight.

Preferred compound examples (b-1) to (b-96) of the cationic polymerization initiator used in the present invention are cited below, but the present invention should not be construed by being limited thereto. In some of the compound examples below, the hydrocarbon chain is described by a simplified structural formula in which symbols for carbon (C) and hydrogen (H) are omitted.

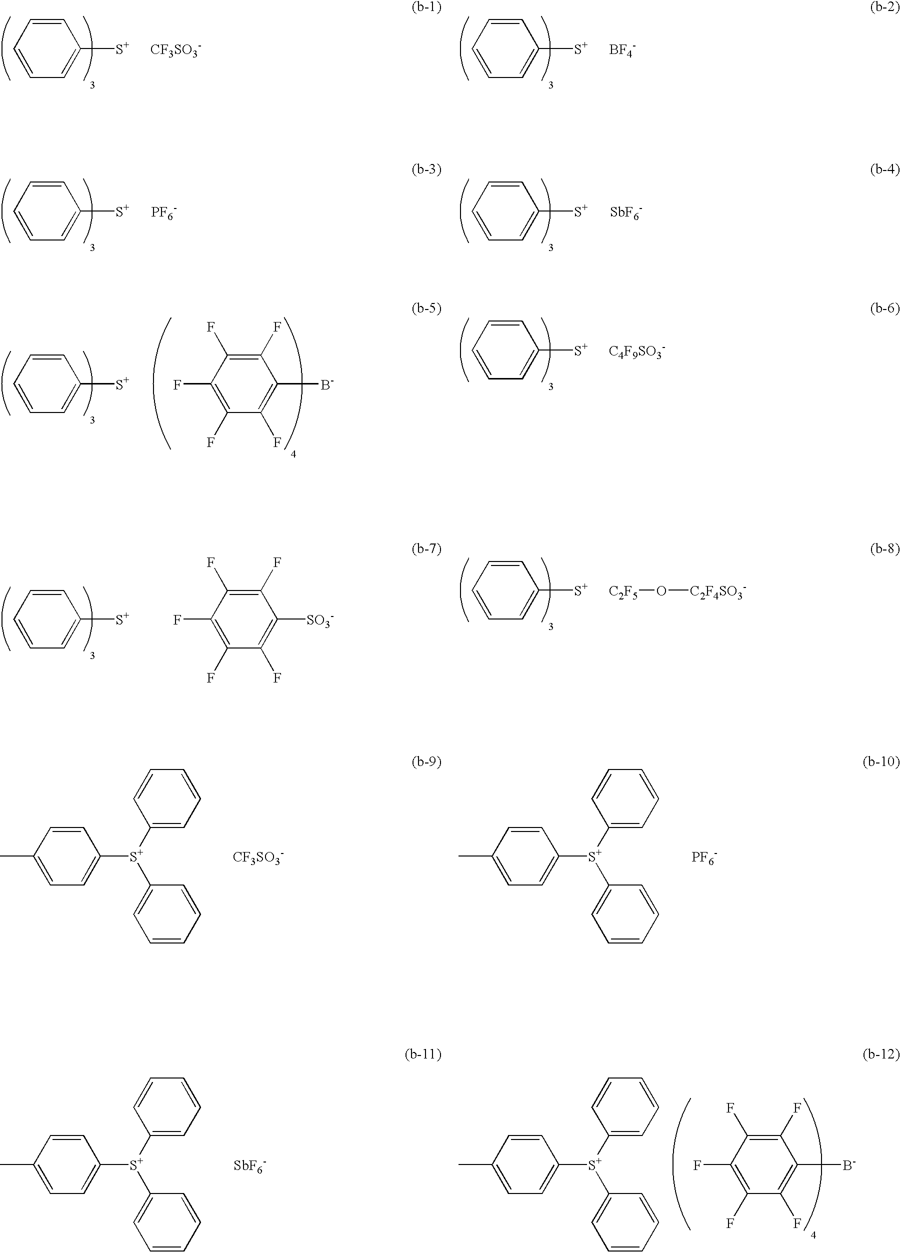

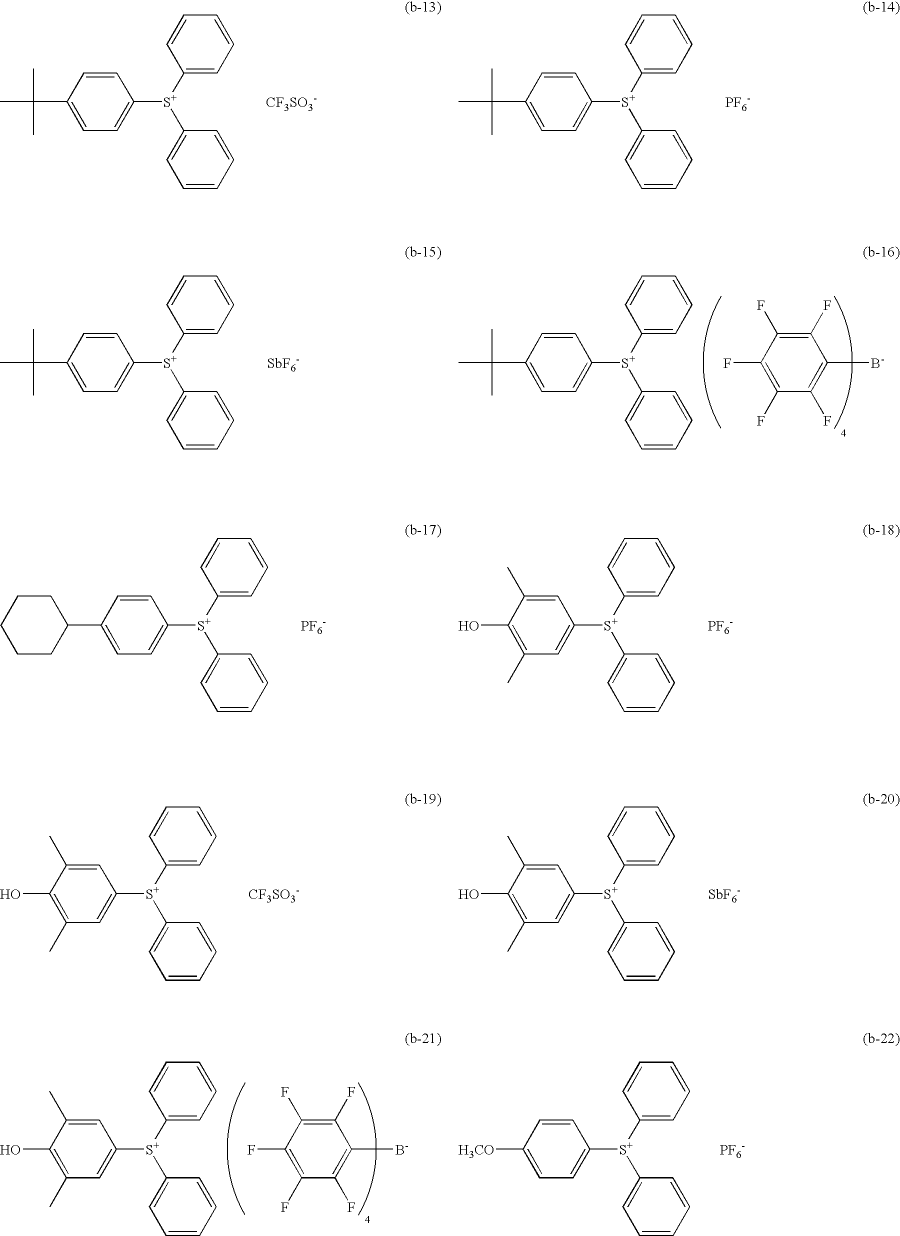

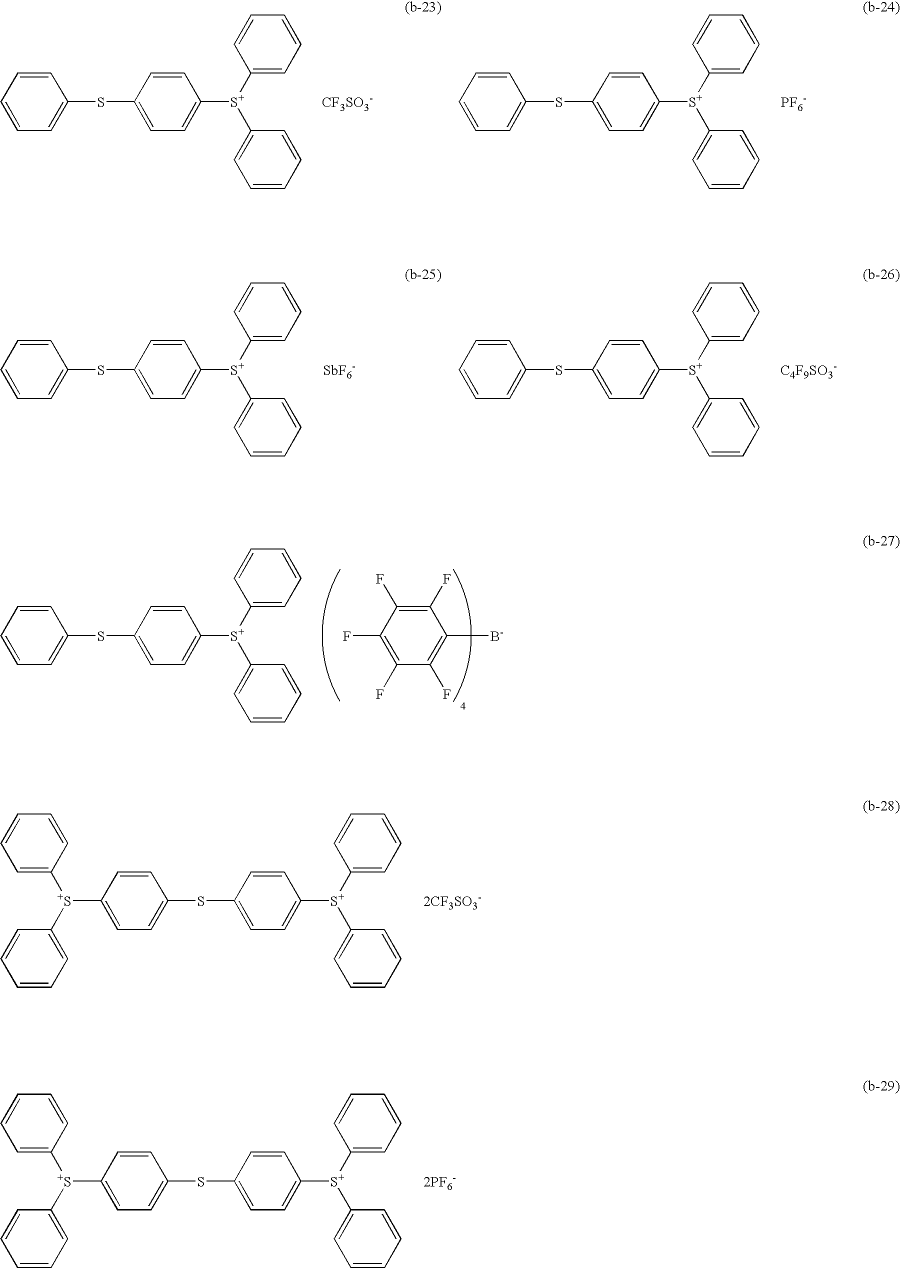

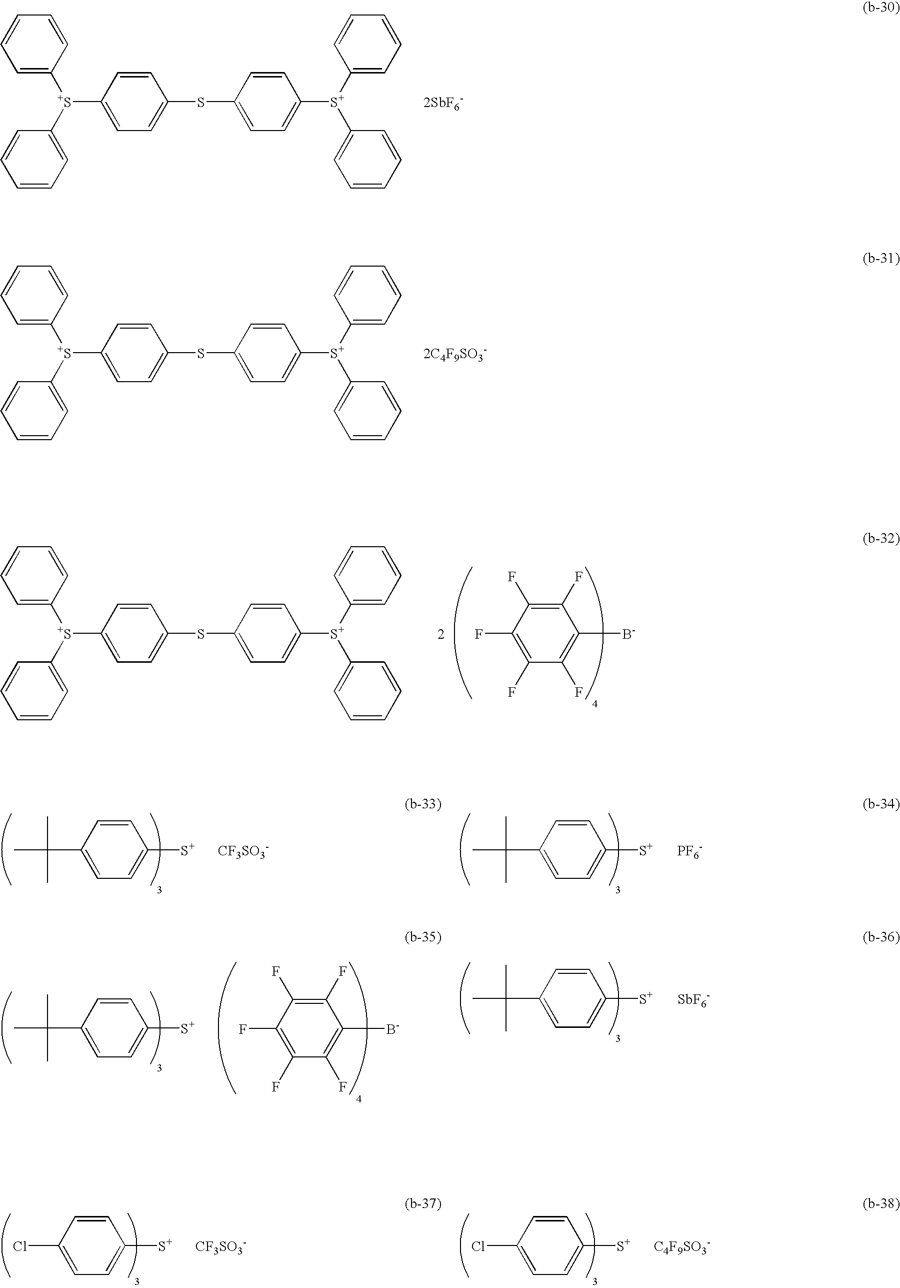

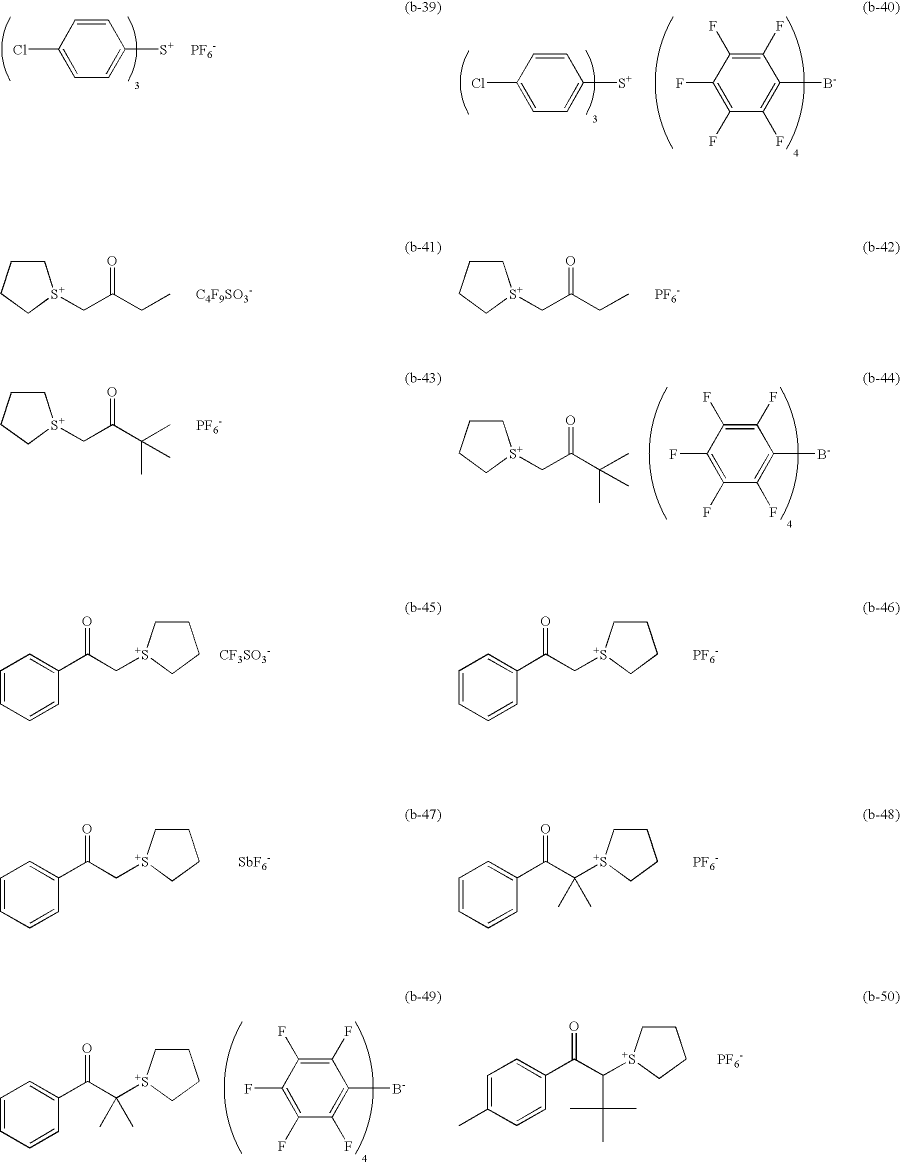

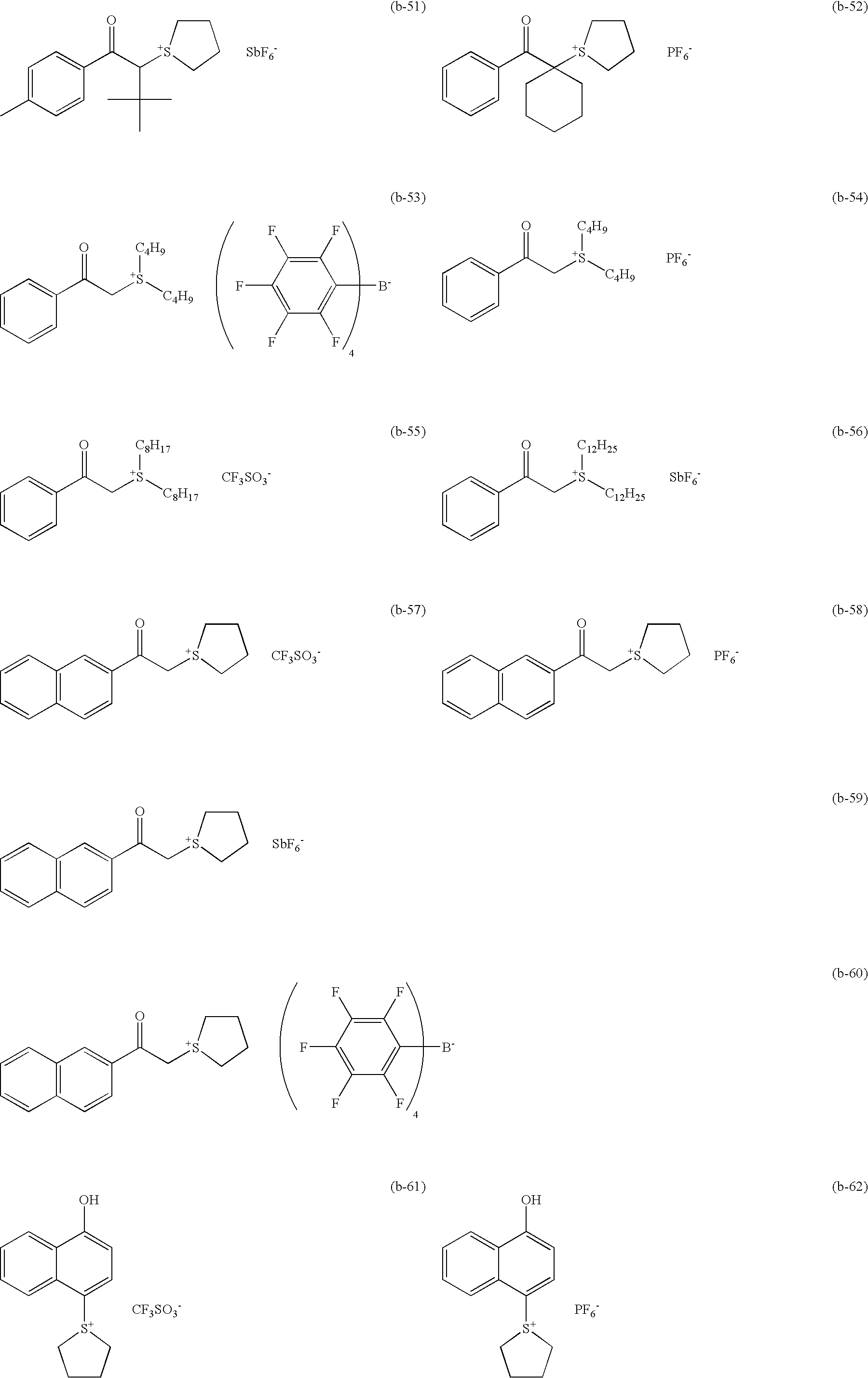

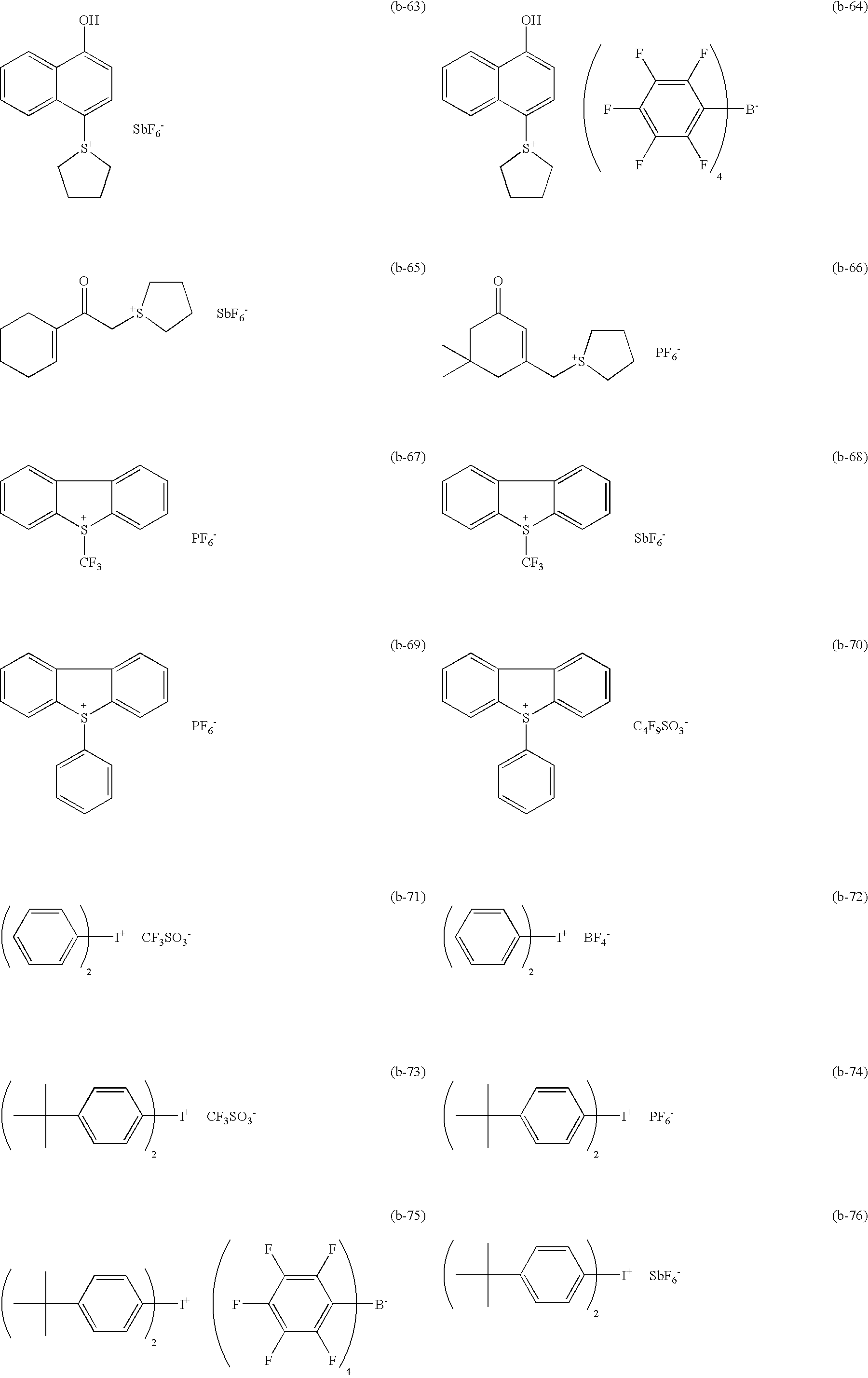

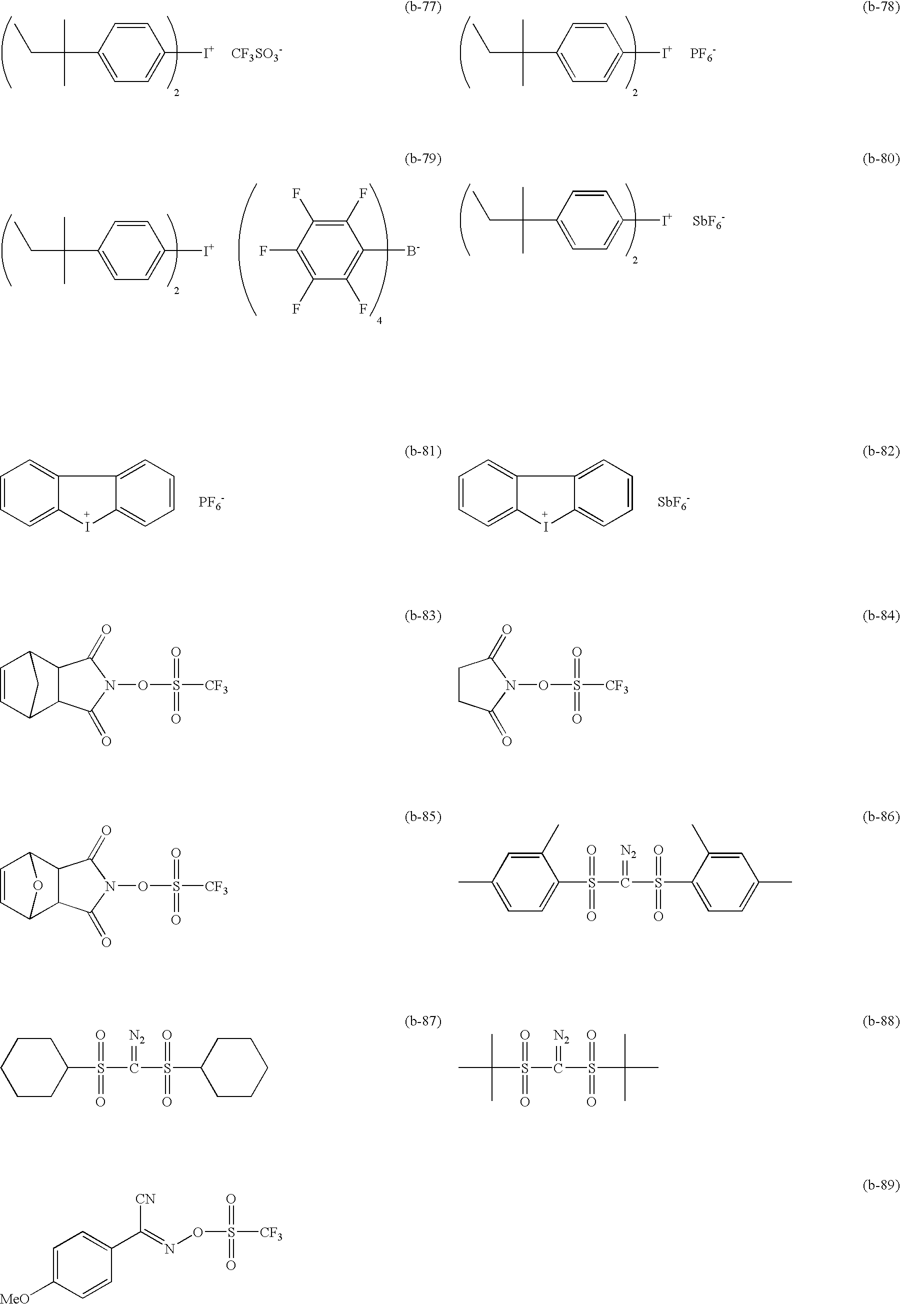

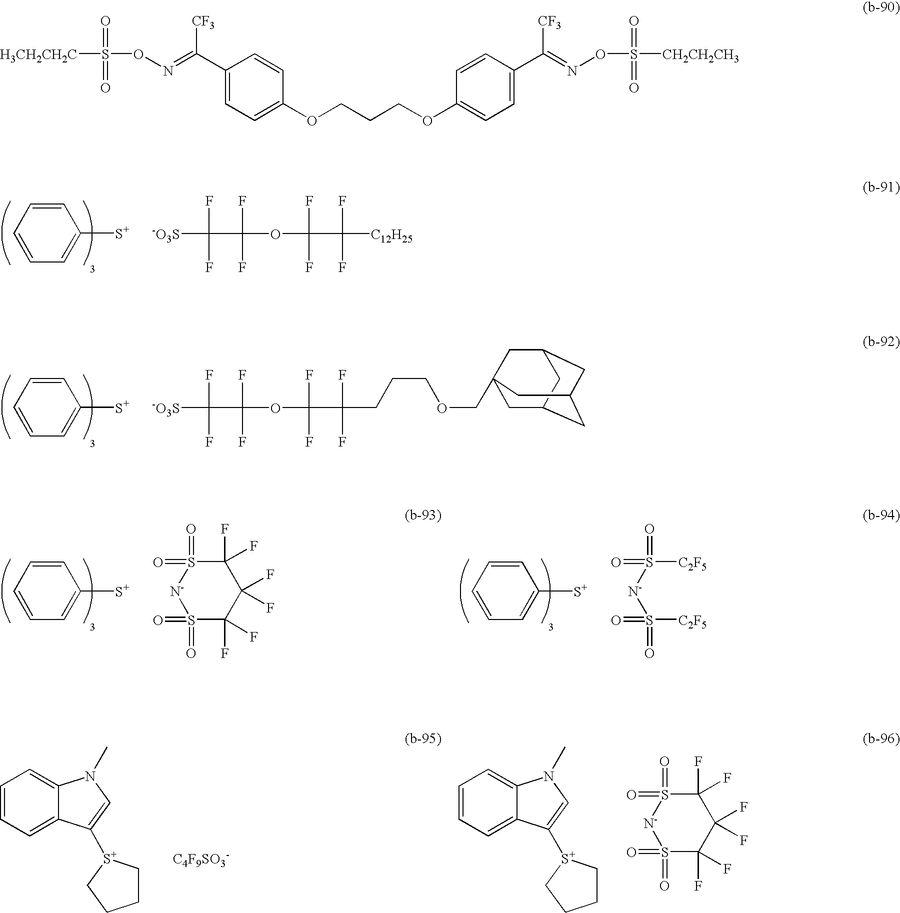

### Colorant

In the present invention, in order to improve the visibility of an image area that is formed, the ink composition preferably contains a colorant.

The coloring agent that can be used in the present invention is not particularly limited, but a pigment and an oil-soluble dye that have excellent weather resistance and rich color reproduction are preferable, and it may be selected from any known coloring agent such as a soluble dye. It is preferable that the coloring agent that can be suitably used in the ink composition or the inkjet recording ink composition of the present invention does not function as a polymerization inhibitor in a polymerization reaction, which is a curing reaction. This is because the sensitivity of the curing reaction by actinic radiation should not be degraded.

The pigment that can be used in the present invention is not particularly limited and, for example, organic and inorganic pigments having the numbers below described in the Color Index may be used.

That is, as a red or magenta pigment, Pigment Red 3, 5, 19, 22, 31, 38, 42, 43, 48:1, 48:2, 48:3, 48:4, 48:5, 49:1, 53:1, 57:1, 57:2, 58:4, 63:1, 81, 81:1, 81:2, 81:3, 81:4, 88, 104, 108, 112, 122, 123, 144, 146, 149, 166, 168, 169, 170, 177, 178, 179, 184, 185, 208, 216, 226, or 257, Pigment Violet 3, 19, 23, 29, 30, 37, 50, or 88, and Pigment Orange 13, 16, 20, or 36; as a blue or cyan pigment, Pigment Blue 1, 15, 15:1, 15:2, 15:3, 15:4, 15:6, 16, 17-1, 22, 27, 28, 29, 36, or 60; as a green pigment, Pigment Green 7, 26, 36, or 50; as a yellow pigment, Pigment Yellow 1, 3, 12, 13, 14, 17, 34, 35, 37, 55, 74, 81, 83, 93, 94, 95, 97, 108, 109, 110, 120, 137, 138, 139, 153, 154, 155, 157, 166, 167, 168, 180, 185, or 193; as a black pigment, Pigment Black 7, 28, or 26; as a white pigment, Pigment White 6, 18, or 21, etc. may be used according to the intended application.

The oil-soluble dye that can be used in the present invention is explained below.

The oil-soluble dye that can be used in the present invention means a dye that is substantially insoluble in water. Specifically, the solubility in water at 25° C. (the mass of dye that can be dissolved in 100 g of water) is no greater than 1 g, preferably no greater than 0.5 g, and more preferably no greater than 0.1 g. Therefore, the oil-soluble dye means a so-called water-insoluble pigment or an oil-soluble dye, and among these the oil-soluble dye is preferable.

Among the oil-soluble dyes that can be used in the present invention, as a yellow dye, any may be used. Examples thereof include aryl or heteryl azo dyes having a coupling component such as a phenol, a naphthol, an aniline, a pyrazolone, a pyridone, or an open-chain active methylene compound; azomethine dyes having a coupling component such as an open-chain active methylene compound; methine dyes such as benzylidene dyes and monomethineoxonol dyes; quinone dyes such as naphthoquinone dyes and anthraquinone dyes; and other dye species such as quinophthalone dyes, nitro/nitroso dyes, acridine dyes, and acridinone dyes.

Among the above-mentioned oil-soluble dyes that can be used in the present invention, as a magenta dye, any may be used. Examples thereof include aryl or heteryl azo dyes having a coupling component such as a phenol, a naphthol, or an aniline; azomethine dyes having a coupling component such as a pyrazolone or a pyrazolotriazole; methine dyes such as arylidene dyes, styryl dyes, merocyanine dyes, and oxonol dyes; carbonium dyes such as diphenylmethane dyes, triphenylmethane dyes, and xanthene dyes; quinone dyes such as naphthoquinones, anthraquinones, or anthrapyridones; and condensed polycyclic dyes such as dioxazine dyes.

Among the oil-soluble dyes that can be used in the present invention, as a cyan dye, any may be used. Examples thereof include indoaniline dyes, indophenol dyes, and azomethine dyes having a coupling component such as a pyrrolotriazole; polymethine dyes such as cyanine dyes, oxonol dyes, and merocyanine dyes; carbonium dyes such as diphenylmethane dyes, triphenylmethane dyes, and xanthene dyes; phthalocyanine dyes; anthraquinone dyes; aryl or heteryl azo dyes having a coupling component such as a phenol, a naphthol, or an aniline; and indigo/thioindigo dyes.

The above-mentioned dyes may be dyes that exhibit respective colors of yellow, magenta, and cyan only after a part of the chromophore dissociates, and in that case the counter cation may be an inorganic cation such as an alkali metal or ammonium, may be an organic cation such as pyridinium or a quaternary ammonium salt, or may be a polymer cation having the above cation as a partial structure.

Although not limited to the following, preferred specific examples thereof include CI Solvent Black 3, 7, 27, 29, and 34; CI Solvent Yellow 14, 16, 19, 29, 30, 56, 82, 93, and 162; CI Solvent Red 1, 3, 8, 18, 24, 27, 43, 49, 51, 72, 73, 109, 122, 132, and 218; CI Solvent Violet 3; CI Solvent Blue 2, 11, 25, 35, 38, 67, and 70; CI Solvent Green 3 and 7; and CI Solvent Orange 2.

Particularly preferred examples thereof include Nubian Black PC-0850, Oil Black HBB, Oil Yellow 129, Oil Yellow 105, Oil Pink 312, Oil Red 5B, Oil Scarlet 308, Vali Fast Blue 2606, Oil Blue BOS (manufactured by Orient Chemical Industries, Ltd.), Aizen Spilon Blue GNH (manufactured by Hodogaya Chemical Co., Ltd.), Neopen Yellow 075, Neopen Magenta SE1378, Neopen Blue 808, Neopen Blue FF4012, and Neopen Cyan FF4238 (manufactured by BASF).

In the present invention, the oil-soluble dye may be used singly or in a combination of two or more types.

Furthermore, another colorant such as a water-soluble dye, a disperse dye, or a pigment may be contained as necessary in a range that does not interfere with the effects of the present invention.

In the present invention, a disperse dye may be used in a range that enables it to be dissolved in a water-immiscible organic solvent. Disperse dyes generally include water-soluble dyes, but in the present invention it is preferable for the disperse dye to be used in a range such that it dissolves in a water-immiscible organic solvent. Specific preferred examples of the disperse dye include CI Disperse Yellow 5, 42, 54, 64, 79, 82, 83, 93, 99, 100, 119, 122, 124, 126, 160, 184:1, 186, 198, 199, 201, 204, 224, and 237; CI Disperse Orange 13, 29, 31:1, 33, 49, 54, 55, 66, 73, 118, 119, and 163; CI Disperse Red 54, 60, 72, 73, 86, 88, 91, 92, 93, 111, 126, 127, 134, 135, 143, 145, 152, 153, 154, 159, 164, 167:1, 177, 181, 204, 206, 207, 221, 239, 240, 258, 277, 278, 283, 311, 323, 343, 348, 356, and 362; CI Disperse Violet 33; CI Disperse Blue 56, 60, 73, 87, 113, 128, 143, 148, 154, 158, 165, 165:1, 165:2, 176, 183, 185, 197, 198, 201, 214, 224, 225, 257, 266, 267, 287, 354, 358, 365, and 368; and CI Disperse Green 6:1 and 9.

The coloring agent that can be used in the present invention is preferably added to the ink composition or the inkjet recording ink composition of the present invention and then dispersed in the ink to an appropriate degree. For dispersion of the coloring agent, for example, a dispersing machine such as a ball mill, a sand mill, an attritor, a roll mill, an agitator, a Henschel mixer, a colloidal mill, an ultrasonic homogenizer, a pearl mill, a wet type jet mill, or a paint shaker may be used.

The coloring agent may be added directly to the ink composition of the present invention with other components, but in order to improve dispersibility it may be added in advance to a solvent or a dispersing medium such as a cationically polymerizable compound used in the present invention.

In the present invention, in order to avoid the problem of the solvent resistance being degraded when the solvent remains in the cured image and the VOC (Volatile Organic Compound) problem of the residual solvent, it is preferable to add the coloring agent in advance to a dispersing medium such as a cationically polymerizable compound. As a polymerizable compound used, it is preferable in terms of dispersion suitability to select a monomer having the lowest viscosity.

These colorants may be used by appropriately selecting one type or two or more types according to the intended purpose of the ink composition.

When a colorant such as a pigment that is present as a solid in the ink composition of the present invention is used, it is preferable for the colorant, the dispersant, the dispersing medium, dispersion conditions, and filtration conditions to be set so that the average particle size of colorant particles is preferably 0.005 to 0.5 μm, more preferably 0.01 to 0.45 μm, and yet more preferably 0.015 to 0.4 μm. By such control of particle size, clogging of a head nozzle can be suppressed, and the ink storage stability, the ink transparency, and the curing sensitivity can be maintained.

The content of the colorant in the ink composition of the present invention is appropriately selected according to the color and the intended purpose, and is preferably 0.01 to 30 wt % relative to the weight of the entire ink composition.

### Sensitizer

In the present invention, the ink composition preferably comprises a sensitizer for the purpose of improving the acid-generating efficiency of the onium-based polymerization initiator and increasing the wavelength at which it exhibits sensitivity. The sensitizer that can be used in the present invention is preferably one that sensitizes the onium-based polymerization initiator by virtue of an electron transfer mechanism or an energy transfer mechanism. The sensitizer is preferably a sensitizing colorant.

Examples of the sensitizer that can be used in the present invention include those belonging to the types of compounds listed below and having an absorption wavelength in the wavelength region of 300 nm to 450 nm.

Examples include polynuclear aromatic compounds (e.g. phenanthrene, anthracene, pyrene, perylene, triphenylene, a 9,10-dialkoxyanthracene), xanthenes (e.g. fluorescein, eosin, erythrosine, rhodamine B, rose bengal), thioxanthones (e.g. isopropylthioxanthone, diethylthioxanthone, chlorothioxanthone), cyanines (e.g. thiacarbocyanine, oxacarbocyanine), merocyanines (e.g. merocyanine, carbomerocyanine), phthalocyanines, thiazines (e.g. thionine, methylene blue, toluidine blue), acridines (e.g. acridine orange, chloroflavin, acriflavin), anthraquinones (e.g. anthraquinone), squariums (e.g. squarium), coumarins (e.g. 7-diethylamino-4-methylcoumarin), ketocoumarin, phenothiazines, phenazines, styrylbenzenes, azo compounds, diphenylmethane, triphenylmethane, distyrylbenzenes, carbazoles, porphyrin, spiro compounds, quinacridone, indigo, styryl, pyrylium compounds, pyrromethene compounds, pyrazolotriazole compounds, benzothiazole compounds, barbituric acid derivatives, thiobarbituric acid derivatives, and compounds described in EP No. 568,993, U.S. Pat. Nos. 4,508,811 and 5,227,227, JP-A-2001-125255, JP-A-11-271969, etc.

Among them, the sensitizer of the present invention is preferably combined with a polynuclear aromatic compound (e.g. phenanthrene, anthracene, pyrene, perylene, triphenylene, a 9,10-dialkoxyanthracene), a thioxanthone, a distyrylbenzene, a styrylbenzene, or a carbazole from the viewpoint of initiation efficiency, and most preferably with a distyrylbenzene, a styrylbenzene, or a diphenylbutadiene.

Specific examples of the sensitizer include the compounds below. In the compounds below, ‘Me’ means methyl group and ‘Bu’ means butyl group.

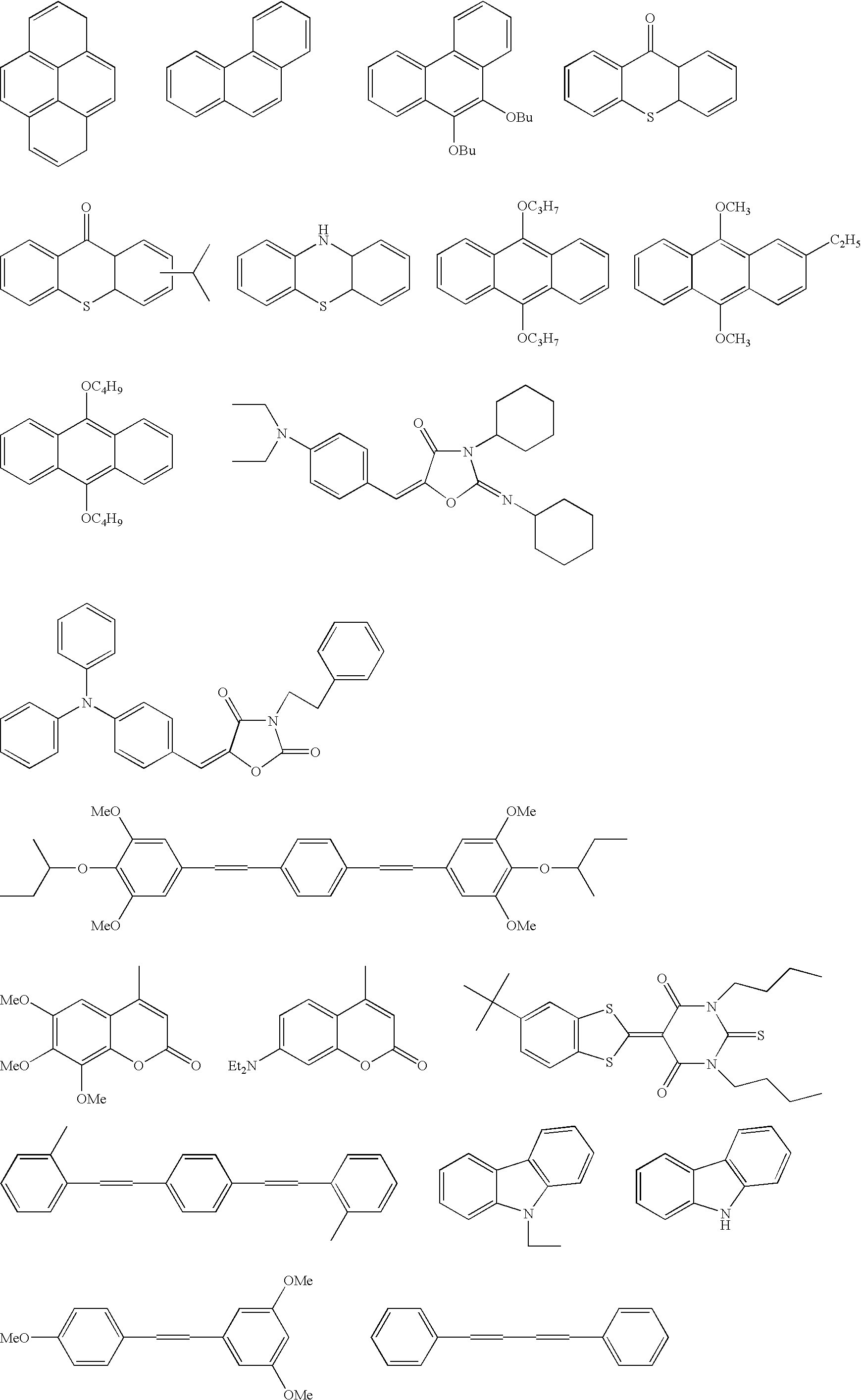

In the present invention, when a sensitizing dye is used as a sensitizer in the ink composition, the content thereof is preferably 0.01 to 20 wt % relative to the total weight of the ink composition from the viewpoint of ink coloration properties, more preferably 0.1 to 15 wt %, and yet more preferably 0.5 to 10 wt %.

One type of sensitizer may be used on its own or a combination of two or more types may be used.

Furthermore, the content ratio of the sensitizer to the onium type polymerization initiator in the ink composition is preferably (onium type polymerization initiator)/(sensitizer)=100 to 0.5 as a ratio by weight from the viewpoint of improvement of decomposition of the onium type polymerization initiator and the penetrability of irradiating light, more preferably 50 to 1, and yet more preferably 10 to 1.5.

### Cosensitizer

In the present invention, the ink composition preferably comprises a cosensitizer. In the present invention, the cosensitizer has the function of further improving the sensitivity of the sensitizing dye to actinic radiation or the function of suppressing inhibition by oxygen of polymerization of a polymerizable compound, etc.

Examples of such a cosensitizer include amines such as compounds described in M. R. Sander et al., ‘Journal of Polymer Society’, Vol. 10, p. 3173 (1972), JP-B-44-20189, JP-A-51-82102, JP-A-52-134692, JP-A-59-138205, JP-A-60-84305, JP-A-62-18537, JP-A-64-33104, and Research Disclosure No. 33825, and specific examples thereof include triethanolamine, ethyl p-dimethylaminobenzoate, p-formyldimethylaniline, and p-methylthiodimethylaniline.

Other examples of the cosensitizer include thiols and sulfides such as thiol compounds described in JP-A-53-702, JP-B-55-500806, and JP-A-5-142772, and disulfide compounds of JP-A-56-75643, and specific examples thereof include 2-mercaptobenzothiazole, 2-mercaptobenzoxazole, 2-mercaptobenzimidazole, 2-mercapto-4(3H)-quinazoline, and β-mercaptonaphthalene.

Yet other examples of the cosensitizer include amino acid compounds (e.g. N-phenylglycine, etc.), organometallic compounds described in JP-B-48-42965 (e.g. tributyltin acetate, etc.), hydrogen-donating compounds described in JP-B-55-34414, sulfur compounds described in JP-A-6-308727 (e.g. trithiane, etc.), phosphorus compounds described in JP-A-6-250387 (diethylphosphite, etc.).

The cosensitizer is preferably added to the ink composition at 1 to 20 wt % of the weight of the entire ink composition (solids basis), and more preferably 1 to 5 wt %. It is preferable for it to be in the above-mentioned range since good sensitivity can be obtained with an appropriate amount thereof used.

### Other Polymerizable Compound

The ink composition that can be used in the present invention may employ another polymerizable compound in combination with the oxetane compound, oxirane compound, and vinyl ether compound. Examples of polymerizable compounds that can be used in combination in the present invention include cationically polymerization compounds that are not corresponding to the oxetane compound, oxirane compound and vinyl ether compound, and radically polymerizable compounds.

As the radically polymerizable compounds that can be used in the present invention, photocurable materials employing a photopolymerizable composition described in JP-A-7-159983, JP-B-7-31399, JP-A-8-224982, JP-A-10-863, etc. are known.

The radically polymerizable compounds that can be used in the present invention are compounds having at least one radically polymerizable carbon-carbon double bond (ethylenically unsaturated bond), may be any compound as long as it has one radically polymerizable ethylenically unsaturated bond in the molecule, and include chemical configurations such as monomer, oligomer, and polymer. The radically polymerizable compounds may be used singly or may be used in a combination of two or more types at any ratio in order to improve desired properties.

Examples of the polymerizable compound having a radically polymerizable ethylenically unsaturated bond include unsaturated carboxylic acids such as acrylic acid, methacrylic acid, itaconic acid, crotonic acid, isocrotonic acid, and maleic acid, and salts thereof, anhydrides having an ethylenically unsaturated group, acrylonitrile, styrene, and various types of radically polymerizable compounds such as unsaturated polyesters, unsaturated polyethers, unsaturated polyamides, and unsaturated urethanes.

Specific examples thereof include acrylic acid derivatives such as 2-ethylhexyl acrylate, 2-hydroxyethyl acrylate, butoxyethyl acrylate, carbitol acrylate, cyclohexyl acrylate, tetrahydrofurfuryl acrylate, benzyl acrylate, diacetone acrylamide, and an epoxyacrylate; methacrylic derivatives such as methyl methacrylate, n-butyl methacrylate, 2-ethylhexyl methacrylate, lauryl methacrylate, allyl methacrylate, glycidyl methacrylate, benzyl methacrylate, and dimethylaminomethyl methacrylate; and allyl compound derivatives such as allyl glycidyl ether. More specifically, commercial products, radically polymerizable or crosslinking monomers, oligomers, and polymers known in the art such as those described in ‘Kakyozai Handobukku’ (Crosslinking Agent Handbook), Ed. S. Yamashita (Taiseisha, 1981); ‘UV•EB Koka Handobukku’ (UV•EB Curing Handbook (Starting Materials) Ed. K. Kato (Kobunshi Kankoukai, 1985); ‘UV•EB Koka Gijutsu no Oyo to Shijyo’ (Application and Market of UV•EB Curing Technology’, p. 79, Ed. Rad Tech (CMC, 1989); and E. Takiyama ‘Poriesuteru Jushi Handobukku’ (Polyester Resin Handbook), (The Nikkan Kogyo Shimbun Ltd., 1988) can be used.

It is preferable to use the radically polymerizable compound and the cationically polymerizable compound in combination since, due to high sensitivity characteristic of radical polymerization and low volume shrinkage characteristic of cationic polymerization, a printed material having both high sensitivity and adhesion is obtained.

### Radical Polymerization Initiator

The ink composition used in the present invention may comprise a cationic polymerization initiator and radical polymerization initiator in combination, and as the radical polymerization initiator, a known radical polymerization initiator can be used. The radical polymerization initiator may be used singly or in a combination of two or more types.

In the present invention, the radical polymerization initiator that can be used in the ink composition is a compound that generates a polymerization initiating species by absorbing external energy. The external energy that is used for initiating polymerization can be broadly divided into heat and actinic radiation, and a thermopolymerization initiator and a photopolymerization initiator are used respectively. Examples of the actinic radiation include γ rays, β rays, an electron beam, UV rays, visible light, and IR rays. The radical polymerization initiator that can be used in the present invention is preferably a radiation-sensitive radical polymerization initiator, which is sensitive to actinic radiation, a so-called radical photopolymerization initiator.

Preferred examples of the radical polymerization initiator that can be used in combination in the present invention include (a) an aromatic ketone, (b) an organic peroxide, (c) a thio compound, (d) a hexaarylbiimidazole compound, (e) a ketoxime ester compound, (f) a borate compound, (g) an azinium compound, (h) a metallocene compound, (i) an active ester compound, (j) a compound having a carbon-halogen bond, and (k) an alkylamine compound. With regard to these radical polymerization initiators, the above-mentioned compounds (a) to (k) may be used singly or in combination.

### Other Components

The ink composition of the present invention may comprise other components as necessary. Examples of the other components include basic compounds, radical polymerization inhibitors, and solvents.

It is preferable to add the basic compound from the viewpoint of improving the storage stability of the ink composition. As the basic compound that can be used in the present invention, a known basic compound may be used and, for example, a basic inorganic compound such as an inorganic salt or a basic organic compound such as an amine is preferably used.

It is preferable to add the radical polymerization inhibitor from the viewpoint of enhancing the storage stability. In the present invention, the ink composition is preferably heated in the range of 40° C. to 80° C. to thus make it less viscous and then discharged, and in order to prevent clogging of a head due to thermal polymerization it is preferable to add a radical polymerization inhibitor. The polymerization inhibitor is preferably added at 200 to 20,000 ppm relative to the total amount of the ink composition. Examples of the polymerization inhibitor include hydroquinone, benzoquinone, p-methoxyphenol, TEMPO (2,2,6,6-tetramethylpiperidine 1-oxyl), TEMPOL (2,2,6,6-tetramethyl-4-piperidinal-1-oxyl), and Al cupferron.

While taking into consideration the ink composition and the inkjet recording ink composition of the present invention being radiation curing type ink compositions, it is preferable for them not to contain any solvent so that the ink compositions can react quickly and be cured immediately after landing. However, as long as the curing speed, etc. of the ink composition is not affected, a specified solvent may be added. In the present invention, as a solvent, an organic solvent or water may be used. In particular, the organic solvent may be added in order to improve the adhesion to a support. The amount of organic solvent is preferably 0.1 to 5 wt % relative to the total amount of the ink composition of the present invention, and more preferably 0.1 to 3 wt %.

As means for preventing the sensitivity from being degraded by a light blocking effect of the coloring agent, which may be added to the ink composition, a combination of a cationically polymerizable compound and a cationic polymerization initiator, or a radical/cationic hybrid curing ink combining a radically polymerizable compound and a radical polymerization initiator in addition to the cationically polymerizable compound and the cationic polymerization initiator may be employed.

In addition to the above, the ink composition of the present invention may contain a known compound as necessary. Examples thereof include a surfactant, a leveling additive, a matting agent and, for adjusting film physical properties, a polyester resin, polyurethane resin, vinyl resin, acrylic resin, rubber resin, or wax, which may be appropriately selected and added. Furthermore, in order to improve the adhesion to a recording medium such as a polyolefin or PET, a tackifier that does not inhibit polymerization is preferably added. Specific examples of the tackifier include high molecular weight tacky polymers described on pp. 5 and 6 of JP-A-2001-49200 (e.g. a copolymer formed from an ester of (meth)acrylic acid and an alcohol having an alkyl group with 1 to 20 carbons, an ester of (meth)acrylic acid and an alicyclic alcohol having 3 to 14 carbons, or an ester of (meth)acrylic acid and an aromatic alcohol having 6 to 14 carbons), and a low molecular weight tackifying resin having a polymerizable unsaturated bond.

### Properties of Ink Composition

While taking into consideration dischargability, the viscosity of the ink composition thus obtained at the discharge temperature (e.g. preferably 25° C. to 80° C., more preferably 25° C. to 75° C.) is preferably 7 to 30 mPa·s, and more preferably 7 to 20 mPa·s.

In the present invention, the ink composition has a viscosity at room temperature (25° C. to 30° C.) of preferably 7 to 500 mPa·s, and more preferably 7 to 200 mPa·s. In the present invention, with regard to the ink composition, it is preferable that its component ratio is appropriately adjusted so that the viscosity is in the above-mentioned range. When the viscosity at room temperature is set to be high, even when a porous recording medium is used, penetration of the ink into the recording medium can be prevented, uncured monomer can be reduced, and the odor can be reduced. Furthermore, ink spreading when ink droplets have landed can be suppressed, and as a result there is the advantage that the image quality is improved.

In the present invention, the surface tension of the ink composition at 25° C. is preferably 20 to 35 mN/m, and yet more preferably 23 to 33 mN/m. When recording is carried out on various types of recording medium such as polyolefin, PET, coated paper, and uncoated paper, from the viewpoint of spread and penetration, it is preferably at least 20 mN/m, and from the viewpoint of wettability it is preferably not more than 35 mN/m.

### Support

A support that can be used in the present invention (in the present invention, the ‘support’ is also called a ‘recording medium’ or a ‘substrate’) is not particularly limited, and a known recording medium suitable for molding may be used.

Specific examples of the material of the support include polyolefin-based resins such as polyethylene, polypropylene, polymethylpentene, polybutene, and an olefin-based thermoplastic elastomer, polyester resins such as polyethylene terephthalate, polybutylene terephthalate, polyethylene naphthalate, a terephthalic acid-isophthalic acid-ethylene glycol copolymer, a terephthalic acid-ethylene glycol-1,4-cyclohexanedimethanol copolymer, and a polyester-based thermoplastic elastomer, polyamide resins such as nylon-6, nylon-9, and nylon-6,6, fluorine-based resins such as polyvinyl fluoride, polyvinylidene fluoride, polyvinylidene trifluoride, an ethylene-ethylene tetrafluoride copolymer, and polyethylene tetrafluoride, an acrylic-based resin, polyvinyl chloride, polystyrene, and a polycarbonate resin.

With regard to the acrylic-based resin, for example, a resin such as polymethyl (meth)acrylate, polyethyl (meth)acrylate, polybutyl (meth)acrylate, a methyl (meth)acrylate-butyl (meth)acrylate copolymer, an ethyl (meth)acrylate-butyl (meth)acrylate copolymer, or a methyl (meth)acrylate-styrene copolymer (the term (meth)acrylate means acrylate or methacrylate) may be used on its own or in a combination of two or more types.

In particular, from the viewpoint of printing being easy and various resistance properties of a finished molded printed material being excellent, it is preferable to use a sheet of polyethylene terephthalate, a polycarbonate resin, or a resin formed by blending a polycarbonate resin with another resin.

The thickness of a thermoplastic resin sheet used as the support in the present invention (the total thickness in the case of a laminate structure) is not particularly limited as long as it is a resin sheet having a thickness in a range that allows vacuum and pressure forming employing in combination the principles of embossing, vacuum forming, pressure forming, and vacuum/pressure forming to be carried out, and it is preferably 50 to 1000 μm, more preferably 70 to 800 μm, and yet more preferably 100 to 500 μm.

It is appropriately selected from thermoplastic resin sheets while taking into consideration suitability for embossing in terms of giving a high gloss region, a low gloss region, and a variation in sheet thickness and, moreover, a balance between molding suitability and embossing durability (preventing disappearance of embossing) due to heat during molding when a printed material is thermally softened and molded by vacuum forming, etc. The layer structure of a thermoplastic resin sheet may be a single layer or a laminate in which two or more layers of different types of resin are laminated.

It is possible to add an appropriate additive to the thermoplastic resin sheet as necessary. As the additive, various types of additive may be added in an appropriate amount such that they do not impair surface gloss or thermal behavior such as melting point. Examples thereof include a photostabilizer such as a benzotriazole-based, benzophenone-based, etc. UV absorber or a hindered amine-based radical scavenger, a lubricant such as a silicone resin or a wax, a colorant, a plasticizer, a heat stabilizer, an antimicrobial agent, an anti-mold agent, and an antistatic agent.

The molded printed material of the present invention may be produced by subjecting the thermoplastic resin sheet to vacuum forming, etc., and an image is formed on the support by an inkjet method prior to molding. An image is generally formed on the reverse side of a transparent sheet (side facing the mold in vacuum forming), but an image may also be formed on the opposite side. It is also possible to form an image only on said opposite side depending on the circumstances, and in this case the thermoplastic resin sheet used as a substrate is not necessarily transparent.

### Production of Printed Material by Inkjet Method

The process for producing a molded printed material of the present invention comprises a step of forming an image by discharging the ink composition on a support by an inkjet method and a step of curing the ink composition by irradiating with actinic radiation the image obtained so as to obtain a printed material having the image cured on the support. The inkjet method is a method in which very small ink droplets are discharged with good reproducibility and land in a desired location.

In order to form an image using the inkjet method, the inkjet recording system described below may suitably be used.

### Inkjet Recording Method and Inkjet Recording Device

In the present invention, an inkjet recording device described in detail below can be used in the step of forming an image by discharging the ink composition on the support using an inkjet system. An inkjet recording device used in the process for producing a molded printed material of the present invention is not particularly limited, and any known inkjet recording device that can achieve an intended resolution may be used. That is, in the present invention, any known inkjet recording device, such as a commercial product, may be used in order to discharge an ink onto a support.

The inkjet recording device that can be used in the present invention is equipped with, for example, an ink supply system, a temperature sensor, and an actinic radiation source.

The ink supply comprises, for example, a main tank containing the ink composition, a supply pipe, an ink supply tank immediately before an inkjet head, a filter, and a piezo system inkjet head. The piezo system inkjet head may be driven so as to discharge a multisize dot of 1 to 100 pL, and preferably 8 to 30 pL, at a resolution of 320×320 to 4,000×4,000 dpi, preferably 400×400 to 1,600×1,600 dpi, and more preferably 720×720 dpi. Here, dpi referred to in the present invention means the number of dots per 2.54 cm.

Since it is desirable for the radiation curing type ink to be discharged at a constant temperature, a section from the ink supply tank to the inkjet head is thermally insulated and heated. A method of controlling temperature is not particularly limited, but it is preferable to provide, for example, temperature sensors at a plurality of pipe section positions, and control heating according to the ink flow rate and the temperature of the surroundings. The temperature sensors may be provided on the ink supply tank and in the vicinity of the inkjet head nozzle. Furthermore, the head unit that is to be heated is preferably thermally shielded or insulated so that the device main body is not influenced by the temperature of the outside air. In order to reduce the printer start-up time required for heating, or in order to reduce the thermal energy loss, it is preferable to thermally insulate the head unit from other sections and also to reduce the heat capacity of the entire heated unit.

The radiation curing type ink composition generally has a viscosity that is higher than that of a normal water-based ink used for an inkjet recording ink, and variation in viscosity due to a change in temperature at the time of discharge is large. Viscosity variation in the ink has a large effect on changes in liquid droplet size and changes in liquid droplet discharge speed and, consequently, causes the image quality to be degraded. It is therefore necessary to maintain the ink discharge temperature as constant as possible. In the present invention, the control range for the temperature is desirably ±5° C. of a set temperature, preferably ±2° C. of the set temperature, and more preferably ±1° C. of the set temperature.

The step (B) of curing the discharged ink composition by irradiating with actinic radiation the image obtained so as to obtain a printed material having the image cured on the support is now explained.

The ink composition discharged onto the support cures upon exposure to actinic radiation. This is due to an acid being generated from the cationic polymerization initiator contained in the ink composition by absorbing actinic radiation and a polymerizable compound undergoing cationic polymerization and being cured. In this process, if a sensitizing colorant is present together with the polymerization initiator in the ink composition, the sensitizing colorant in the system absorbs actinic radiation, becomes excited, and promotes generation of an acid by the polymerization initiator by contact with the polymerization initiator, thus enabling a curing reaction with higher sensitivity to be achieved.

The actinic radiation used in this process may include α rays, γ rays, an electron beam, X rays, UV rays, visible light, and IR rays. Although it depends on the absorption characteristics of the sensitizing dye, the peak wavelength of the actinic radiation is, for example, 200 to 600 nm, preferably 300 to 450 nm, and more preferably 350 to 420 nm.

Furthermore, in the present invention, the polymerization initiation system of the ink composition has sufficient sensitivity for low output actinic radiation. The actinic radiation is applied therefore so that the illumination intensity on the exposed surface is, for example, 10 to 4,000 mW/cm², and preferably 20 to 2,500 mW/cm².

As an actinic radiation source, a mercury lamp, a gas/solid laser, etc. are mainly used, and for UV photocuring inkjet a mercury lamp and a metal halide lamp are widely known. However, from the viewpoint of protection of the environment, there has recently been a strong desire for mercury not to be used, and replacement by a GaN semiconductor UV light emitting device is very useful from industrial and environmental viewpoints. Furthermore, LEDs (UV-LED) and LDs (UV-LD) have small dimensions, long life, high efficiency, and low cost, and their use as a photocuring inkjet light source can be expected.

Furthermore, light-emitting diodes (LED) and laser diodes (LD) may be used as the source of actinic radiation. In particular, when a UV ray source is needed, a UV-LED or a UV-LD may be used. For example, Nichia Corporation has marketed a violet LED having a wavelength of the main emission spectrum of between 365 nm and 420 nm. Furthermore, when a shorter wavelength is needed, U.S. Pat. No. 6,084,250 discloses an LED that can emit actinic radiation whose wavelength is centered between 300 nm and 370 nm. Furthermore, another UV-LED is available, and irradiation can be carried out with radiation of a different UV bandwidth. The actinic radiation source particularly preferable in the present invention is a UV-LED, and a UV-LED having a peak wavelength at 350 to 420 nm is particularly preferable.

The maximum illumination intensity of the LED on a recording medium is preferably 10 to 2,000 mW/cm², more preferably 20 to 1,000 mW/cm², and particularly preferably 50 to 800 mJ/cm².

The ink composition of the present invention is desirably exposed to such actinic radiation for, for example, 0.01 to 120 sec., and preferably 0.1 to 90 sec.

Irradiation conditions and a basic method for irradiation with actinic radiation are disclosed in JP-A-60-132767. Specifically, a light source is provided on either side of a head unit that includes an ink discharge device, and the head unit and the light source are made to scan by a so-called shuttle system. Irradiation with actinic radiation is carried out after a certain time (e.g. 0.01 to 0.5 sec., preferably 0.01 to 0.3 sec., and more preferably 0.01 to 0.15 sec.) has elapsed from when the ink has landed. By controlling the time from ink landing to irradiation so as to be a minimum in this way, it becomes possible to prevent the ink that has landed on a support from spreading before being cured. Furthermore, since the ink can be exposed before it reaches a deep area of a porous support that the light source cannot reach, it is possible to prevent monomer from remaining unreacted, and as a result the odor can be reduced.

Furthermore, curing may be completed using another light source that is not driven. WO99/54415 discloses, as an irradiation method, a method employing an optical fiber and a method in which a collimated light source is incident on a mirror surface provided on a head unit side face, and a recorded area is irradiated with UV light.

By employing such a recording method, it is possible to maintain a uniform dot diameter for landed ink even for various types of support having different surface wettability, thereby improving the image quality. In order to obtain a color image, it is preferable to superimpose colors in order from those with a low lightness. By superimposing inks in order from one with low lightness, it is easy for radiation to reach a lower ink, the curing sensitivity is good, the amount of residual monomer decreases, odor is reduced, and an improvement in adhesion can be expected. Furthermore, although it is possible to discharge all colors and then expose them at the same time, it is preferable to expose one color at a time from the viewpoint of promoting curing.

### Molding

The present invention comprises a step of molding a printed material having a cured image. As molding in the present invention, embossing, vacuum forming, pressure forming, or vacuum/pressure forming may be employed.

As a system for molding a printed material, a known system may be used, and the system may be integral with the inkjet recording system or separate therefrom.

### Embossing

Embossing is a process in which a three-dimensional feel is given by indenting a printed material, etc. in a desired shape such as a pattern or a letter, and may be carried out using a roller, a press, etc.

Examples of embossing include a hot/cold pressing method, and a method described in JP-A-10-199360, etc. may be referred to.

One example of an embossing system employing the hot/cold pressing method is shown below.

In the embossing system, a lower platen and an upper platen are disposed so that they can move toward and away from each other. A plate-shaped heater is fixed on top of the lower platen, and a plate-shaped heater is also fixed to a lower face of the upper platen. This enables a support to be hot pressed while it is heated. In this hot pressing machine, the plate-shaped heater on the lower platen is equipped with a mold having a projection following a predetermined embossing shape, and a mold having a recess that conforms to the shape of the projection is mounted so as to be in contact with the heater fixed to the lower face of the upper platen. A support having an image formed thereon is positioned, a cushion sheet is placed between the support and the mold with the recess, and the support and the cushion sheet are pressed between the upper platen and the lower platen by lowering the upper platen, etc. A pressure applied in this hot pressing step is, for example, 30 tons, and the heating temperature from the plate-shaped heater is, for example, 170° C. The upper platen is pressed against the lower platen, the support and the cushion sheet are sandwiched between the molds, and this hot pressing is maintained for about 3 minutes. The support is heated by the heaters via the molds, and a plurality of projections are formed due to thermal deformation. Subsequently, the support and the cushion sheet sandwiched between the molds are subjected to cold pressing by placing them between internally water-cooled platens without heaters and applying a pressure of, for example, 30 tones by pressing the platens for about 3 minutes. This enables an embossed molded printed material to be obtained in which the support has a projecting shape due to thermal deformation by the hot pressing. The pressure applied and the heating temperature may be adjusted appropriately according to the material of the printed material and conditions such as the shape that is to be formed, etc.

### Vacuum Forming Pressure Forming and Vacuum/Pressure Forming

Vacuum forming is a method in which a support having an image formed thereon is preheated to a temperature at which it can be thermally deformed, and molding is carried out by pressing it against a mold and cooling while sucking it toward the mold by means of reduced pressure and stretching it; pressure forming is a method in which a support having an image formed thereon is preheated to a temperature at which it can be thermally deformed, and molding is carried out by pressing it against a mold by applying pressure from the side opposite to the mold and cooling. Vacuum/pressure forming is a method in which molding is carried out by means of the above-mentioned reduced pressure and application of pressure at the same time. In detail, the ‘Thermal Molding’ section described on p. 766 to 768 of ‘Kobunshi Daijiten’ (Polymer Dictionary) (Maruzen) and publications cited in the section, etc. may be referred to.

In accordance with the present invention, there can be provided a process for producing a molded printed material in which cracks and pinholes are not generated when carrying out molding such as embossing, vacuum forming, pressure forming, or vacuum/pressure forming, and a molded printed material obtained by the above production process.

### EXAMPLES

The present invention is explained in further detail by reference to Examples and Comparative Examples. However, the present invention should not be construed as being limited to these Examples.

‘Parts’ described below means ‘parts by weight’ unless otherwise specified.

Materials used in the present invention are as listed below.

### Pigments

IRGALITE BLUE GLVO (cyan pigment, manufactured by Ciba Specialty Chemicals)
CINQUASIA MAGENTA RT-335 D (magenta pigment, manufactured by Ciba Specialty Chemicals)
NOVOPERM YELLOW H2G (yellow pigment, manufactured by Clariant)
SPECIAL BLACK 250 (black pigment, manufactured by Ciba Specialty Chemicals)
Tipaque CR60-2 (white pigment, manufactured by Ishihara Sangyo Kaisha Ltd.)

### Dispersants

Solsperse 32000 (manufactured by Noveon)
Solsperse 36000 (manufactured by Noveon)

### Monomers

RAPI-CURE DVE-3 (triethylene glycol divinyl ether, manufactured by ISP)

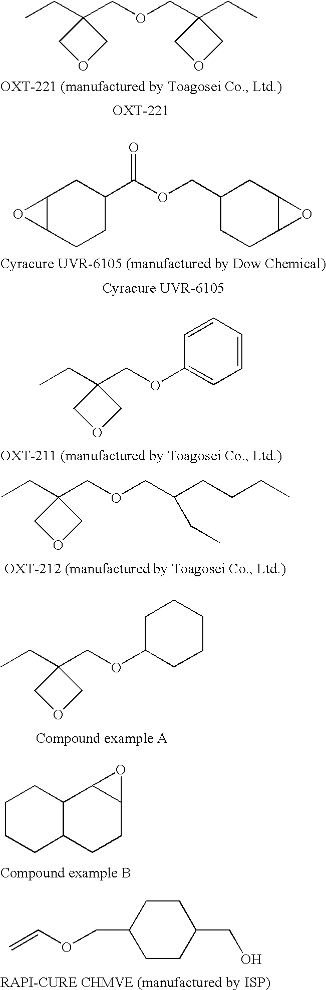

### Polymerization Initiator

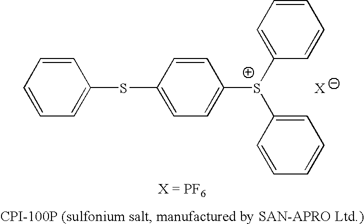

### Sensitizer

9,10-Dibutoxyanthracene (manufactured by Kawasaki Kasei Chemicals Ltd.)

### Surfactant

BYK-307 (manufactured by BYK Chemie)

### Preparation of Cyan Mill Base A

300 parts by weight of IRGALITE BLUE GLVO, 600 parts by weight of OXT-212, and 100 parts by weight of Solsperse 32000 were mixed by stirring to give a pigment mill base. Preparation of the pigment mill base was carried out by putting it into an M50 disperser motor mill (manufactured by Eiger) and dispersing using zirconia beads having a diameter of 0.65 mm at a peripheral speed of 9 m/s for 3 hours.

### Preparation of Magenta Mill Base B

300 parts by weight of CINQUASIA MAGENTA RT-335 D, 600 parts by weight of OXT-212, and 100 parts by weight of Solsperse 32000 were mixed by stirring to give a pigment mill base. Preparation of the pigment mill base was carried out by putting it into an M50 disperser motor mill (manufactured by Eiger) and dispersing using zirconia beads having a diameter of 0.65 mm at a peripheral speed of 9 m/s for 8 hours.

### Preparation of Yellow Mill Base C

300 parts by weight of NOVOPERM YELLOW H2G, 600 parts by weight of OXT-212, and 100 parts by weight of Solsperse 32000 were mixed by stirring to give a pigment mill base. Preparation of the pigment mill base was carried out by putting it into an M50 disperser motor mill (manufactured by Eiger) and dispersing using zirconia beads having a diameter of 0.65 mm at a peripheral speed of 9 m/s for 8 hours.

### Preparation of Black Mill Base D

300 parts by weight of SPECIAL BLACK 250, 600 parts by weight of OXT-212, and 100 parts by weight of Solsperse 32000 were mixed by stirring to give a pigment mill base. Preparation of the pigment mill base was carried out by putting it into an M50 disperser motor mill (manufactured by Eiger) and dispersing using zirconia beads having a diameter of 0.65 mm at a peripheral speed of 9 m/s for 5.5 hours.

### Preparation of White Mill Base E

500 parts by weight of Tipaque CR60-2, 450 parts by weight of OXT-212, and 50 parts by weight of Solsperse 36000 were mixed by stirring to give a pigment mill base. Preparation of the pigment mill base was carried out by putting it into an M50 disperser motor mill (manufactured by Eiger) and dispersing using zirconia beads having a diameter of 0.65 mm at a peripheral speed of 9 m/s for 3 hours.

### Inkjet Image Recording Method

Subsequently, recording was carried out on a recording medium using an experimental inkjet recording system having a piezo system inkjet nozzle. The ink supply system comprised a main tank, a supply pipe, an ink supply tank immediately before an inkjet head, a filter, and a piezo system inkjet head, and a section from the ink supply tank to the inkjet head was thermally insulated and heated. Temperature sensors were provided on the ink supply tank and in the vicinity of the nozzle of the inkjet head, and the temperature was controlled so that the nozzle section was always at 45° C. ±2° C. The piezo system inkjet head was driven so as to discharge multisize dots of 8 to 30 pL at a resolution of 720×720 dpi. The exposure system, the main scanning speed, and the discharge frequency were adjusted so that, after landing, UV light was focused to give an exposure area illumination intensity of 2,100 mW/cm², and irradiation started 0.1 sec. after the ink landed on the recording medium. The cumulative amount of light applied to an image was adjusted so as to be 6,000 mJ/cm². The UV lamp employed an HAN250NL high-cure mercury lamp (manufactured by GS Yuasa Corporation). Here, the dpi referred to in the present invention denotes the number of dots per 2.54 cm. As a recording medium, HK31-WF (film thickness 120 μm, PET, manufactured by Higashiyama Film Corporation) was used for the embossing test below, and Teflex FT-3 (film thickness 50 μm, PET, manufactured by Teijin DuPont Films Japan Ltd.) was used for a vacuum forming process test. Printing was carried out so that each sample had an average film thickness of 12 μm for the cured ink coating.

### Forming Process Evaluation Method

### Embossing Test

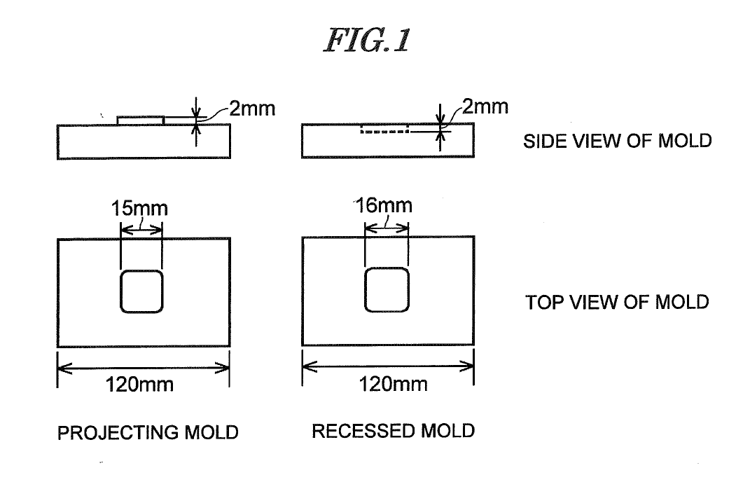

Under conditions of 25° C., a printed material thus formed was sandwiched between stainless steel projecting and recessed molds shown in FIG. 1, and a load of 250 kg was applied thereto for 5 sec using a MIZUHO model A hand power press (manufactured by Matsushita Dendo Kogu K.K.), thus carrying out embossing. The embossed area on the image was visually examined for the occurrence of cracks or pinholes.

### Vacuum Forming Test

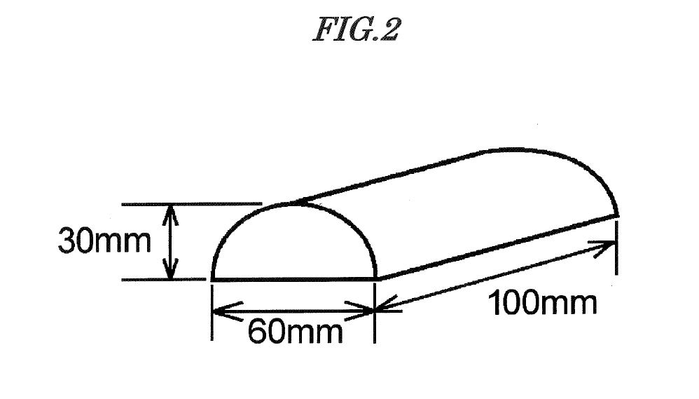

Vacuum forming was carried out using a Forming 300X vacuum forming system (manufactured by Seiko Sangyo Co., Ltd.). A wooden mold shown in FIG. 2 was placed at the center of a vacuum table of the vacuum forming system, and the temperature of a heater was set so that the temperature of a support became 90° C. After the support temperature reached 90° C., the vacuum table on which the wooden mold was placed was gradually raised by operating a table raise/lower lever, thus carrying out vacuum forming. The molded printed material was visually examined for the occurrence of cracks or pinholes.

### Viscosity Measurement Method

Measurement of viscosity in the Examples was carried out using a Brookfield LVDV-I type B viscometer (manufactured by Brookfield) at 25° C. with a rotor rotational speed of 12 rpm.

### Example 1

The components below were stirred using a high-speed water-cooled stirrer to give a cyan UV inkjet ink. The viscosity was 30 mPa·s.

### Cyan Ink Composition

| | | |
|---|---|---|
| Cyan mill base A (colorant, monomer: monofunctional | 6.0 | parts |
| oxetane, polymeric dispersant) | | |
| OXT-221 (monomer: difunctional oxetane) | 11.0 | parts |
| UVR-6105 (monomer: difunctional oxirane) | 9.9 | parts |
| OXT-211 (monomer: monofunctional oxetane) | 60.0 | parts |
| CPI-100P (polymerization initiator) | 12.0 | parts |
| Dibutoxyanthracene (sensitizer) | 1.0 | part |
| BYK-307 (surfactant) | 0.1 | parts |

### Ink Evaluation

Inkjet recording was carried out using the ink composition thus obtained. The embossing test and the vacuum forming test were carried out using the printed material thus obtained. The results are given in Table 1.

### Example 2

The components below were stirred using a high-speed water-cooled stirrer to give a magenta UV inkjet ink. The viscosity was 33 mPa·s.

### Magenta Ink Composition

| | | |
|---|---|---|
| Magenta mill base B (colorant, monomer: monofunctional | 12.0 | parts |
| oxetane, polymeric dispersant) | | |
| OXT-221 (monomer: difunctional oxetane) | 11.0 | parts |
| UVR-6105 (monomer: difunctional oxirane) | 11.9 | parts |
| OXT-211 (monomer: monofunctional oxetane) | 52.0 | parts |
| CPI-100P (polymerization initiator) | 12.0 | parts |
| Dibutoxyanthracene (sensitizer) | 1.0 | part |
| BYK-307 (surfactant) | 0.1 | parts |

### Ink Evaluation

Inkjet recording was carried out using the ink composition thus obtained. The embossing test and the vacuum forming test were carried out using the printed material thus obtained. The results are given in Table 1.

### Example 3

The components below were stirred using a high-speed water-cooled stirrer to give a yellow UV inkjet ink. The viscosity was 34 mPa·s.

### Yellow Ink Composition

| | | |
|---|---|---|
| Yellow mill base C (colorant, monomer: monofunctional | 12.0 | parts |
| oxetane, polymeric dispersant) | | |
| OXT-221 (monomer: difunctional oxetane) | 11.0 | parts |
| UVR-6105 (monomer: difunctional oxirane) | 11.9 | parts |
| OXT-211 (monomer: monofunctional oxetane) | 52.0 | parts |
| CPI-100P (polymerization initiator) | 12.0 | parts |
| Dibutoxyanthracene (sensitizer) | 1.0 | part |
| BYK-307 (surfactant) | 0.1 | parts |

### Ink Evaluation

Inkjet recording was carried out using the ink composition thus obtained. The embossing test and the vacuum forming test were carried out using the printed material thus obtained. The results are given in Table 1.

### Example 4

The components below were stirred using a high-speed water-cooled stirrer to give a black UV inkjet ink. The viscosity was 31 mPa·s.

### Black Ink Composition

| | | |
|---|---|---|
| Black mill base D (colorant, monomer: monofunctional | 6.0 | parts |
| oxetane, polymeric dispersant) | | |
| OXT-221 (monomer: difunctional oxetane) | 11.0 | parts |
| UVR-6105 (monomer: difunctional oxirane) | 9.9 | parts |
| OXT-211 (monomer: monofunctional oxetane) | 60.0 | parts |
| CPI-100P (polymerization initiator) | 12.0 | parts |
| Dibutoxyanthracene (sensitizer) | 1.0 | part |
| BYK-307 (surfactant) | 0.1 | parts |

### Ink Evaluation

Inkjet recording was carried out using the ink composition thus obtained. The embossing test and the vacuum forming test were carried out using the printed material thus obtained. The results are given in Table 1.

### Example 5

The components below were stirred using a high-speed water-cooled stirrer to give a white UV inkjet ink. The viscosity was 36 mPa·s.

### White Ink Composition

| | | |
|---|---|---|
| White mill base D (colorant, monomer: monofunctional | 30.0 | parts |
| oxetane, polymeric dispersant) | | |
| OXT-221 (monomer: difunctional oxetane) | 10.0 | parts |
| UVR-6105 (monomer: difunctional oxirane) | 8.9 | parts |
| OXT-211 (monomer: monofunctional oxetane) | 40.0 | parts |
| CPI-100P (polymerization initiator) | 10.0 | parts |
| Dibutoxyanthracene (sensitizer) | 1.0 | part |
| BYK-307 (surfactant) | 0.1 | parts |

### Ink Evaluation

Inkjet recording was carried out using the ink composition thus obtained. The embossing test and the vacuum forming test were carried out using the printed material thus obtained. The results are given in Table 1.

### Example 6

The components below were stirred using a high-speed water-cooled stirrer to give a cyan UV inkjet ink. The viscosity was 28 mPa·s.

### Cyan Ink Composition

| | | |
|---|---|---|
| Cyan mill base A (colorant, monomer: monofunctional | 6.0 | parts |
| oxetane, polymeric dispersant) | | |
| OXT-221 (monomer: difunctional oxetane) | 11.0 | parts |
| UVR-6105 (monomer: difunctional oxirane) | 9.9 | parts |
| Compound example A (monomer: monofunctional oxetane) | 60.0 | parts |
| CPI-100P (polymerization initiator) | 12.0 | parts |
| Dibutoxyanthracene (sensitizer) | 1.0 | part |
| BYK-307 (surfactant) | 0.1 | parts |

### Ink Evaluation

Inkjet recording was carried out using the ink composition thus obtained. The embossing test and the vacuum forming test were carried out using the printed material thus obtained. The results are given in Table 1.

### Example 7

The components below were stirred using a high-speed water-cooled stirrer to give a cyan UV inkjet ink. The viscosity was 28 mPa·s.

### Cyan Ink Composition

| | | |
|---|---|---|
| Cyan mill base A (colorant, monomer: monofunctional | 6.0 | parts |
| oxetane, polymeric dispersant) | | |
| OXT-221 (monomer: difunctional oxetane) | 11.0 | parts |
| UVR-6105 (monomer: difunctional oxirane) | 9.9 | parts |
| OXT-211 (monomer: monofunctional oxetane) | 30.0 | parts |
| Compound example B (monomer: monofunctional oxirane) | 30.0 | parts |
| CPI-100P (polymerization initiator) | 12.0 | parts |
| Dibutoxyanthracene (sensitizer) | 1.0 | part |
| BYK-307 (surfactant) | 0.1 | parts |

### Ink Evaluation

Inkjet recording was carried out using the ink composition thus obtained. The embossing test and the vacuum forming test were carried out using the printed material thus obtained. The results are given in Table 1.

### Example 8

The components below were stirred using a high-speed water-cooled stirrer to give a cyan UV inkjet ink. The viscosity was 32 mPa·s.

### Cyan Ink Composition

| | | |
|---|---|---|
| Cyan mill base A (colorant, monomer: monofunctional | 6.0 | parts |
| oxetane, polymeric dispersant) | | |
| OXT-221 (monomer: difunctional oxetane) | 11.0 | parts |
| UVR-6105 (monomer: difunctional oxirane) | 9.9 | parts |
| OXT-211 (monomer: monofunctional oxetane) | 45.0 | parts |
| RAPI-CURE CHMVE (monomer: monofunctional vinyl | 15.0 | parts |
| ether) | | |
| CPI-100P (polymerization initiator) | 12.0 | parts |
| Dibutoxyanthracene (sensitizer) | 1.0 | part |
| BYK-307 (surfactant) | 0.1 | parts |

### Ink Evaluation

Inkjet recording was carried out using the ink composition thus obtained. The embossing test and the vacuum forming test were carried out using the printed material thus obtained. The results are given in Table 1.

### Example 9

The components below were stirred using a high-speed water-cooled stirrer to give a white UV inkjet ink. The viscosity was 28 mPa·s.

### White Ink Composition

| | | |
|---|---|---|
| White mill base E (colorant, monomer: monofunctional | 30.0 | parts |
| oxetane, polymeric dispersant) | | |
| OXT-221 (monomer: difunctional oxetane) | 10.0 | parts |
| UVR-6105 (monomer: difunctional oxirane) | 9.5 | parts |
| OXT-211 (monomer: monofunctional oxetane) | 26.5 | parts |
| RAPI-CURE DVE-3 (monomer: difunctional vinyl ether) | 10.9 | parts |
| CPI-100P (polymerization initiator) | 12.0 | parts |
| Dibutoxyanthracene (sensitizer) | 1.0 | part |
| BYK-307 (surfactant) | 0.1 | parts |

### Ink Evaluation

Inkjet recording was carried out using the ink composition thus obtained. The embossing test and the vacuum forming test were carried out using the printed material thus obtained. The results are given in Table 1.

### Comparative Example 1

The components below were stirred using a high-speed water-cooled stirrer to give a cyan UV inkjet ink. The viscosity was 27 mPa·s.

### Cyan Ink Composition

| | | |
|---|---|---|
| Cyan mill base A (colorant, monomer: monofunctional | 6.0 | parts |
| oxetane, polymeric dispersant) | | |
| OXT-221 (monomer: difunctional oxetane) | 45.0 | parts |
| UVR-6105 (monomer: difunctional oxirane) | 35.9 | parts |
| CPI-100P (polymerization initiator) | 12.0 | parts |
| Dibutoxyanthracene (sensitizer) | 1.0 | part |
| BYK-307 (surfactant) | 0.1 | parts |

### Ink Evaluation

Inkjet recording was carried out using the ink composition thus obtained. The embossing test and the vacuum forming test were carried out using the printed material thus obtained. The results are given in Table 1.

### Comparative Example 2

The components below were stirred using a high-speed water-cooled stirrer to give a cyan UV inkjet ink. The viscosity was 29 mPa·s.

### Cyan Ink Composition

| | | |
|---|---|---|
| Cyan mill base A (colorant, monomer: monofunctional | 6.0 | parts |
| oxetane, polymeric dispersant) | | |
| OXT-221 (monomer: difunctional oxetane) | 28.9 | parts |
| UVR-6105 (monomer: difunctional oxirane) | 32.0 | parts |
| OXT-211 (monomer: monofunctional oxetane) | 20.0 | parts |
| CPI-100P (polymerization initiator) | 12.0 | parts |
| Dibutoxyanthracene (sensitizer) | 1.0 | part |
| BYK-307 (surfactant) | 0.1 | parts |

### Ink Evaluation

Inkjet recording was carried out using the ink composition thus obtained. The embossing test and the vacuum forming test were carried out using the printed material thus obtained. The results are given in Table 1.

The amount of OXT-212 given in Table 1 is the amount contained in the mill base introduced into each formulation.

TABLE 1

| | | | Monomer formulation | | | | |
|---|---|---|---|---|---|---|---|
| | | | | | Total amount of | | |
| | | | | Amount | monofunctional | | Vacuum |
| | Viscosity | | | added | monomer | Embossing | forming |
| | [mPa · s] | Color | Type of monomer | [wt %] | [wt %] | test | test |
| Ex. 1 | 30 | Cyan | Polyfunctional oxetane | 11.0 | 63.6 | Good | Good |
| | | | (OXT-221) | | | | |
| | | | Polyfunctional | 9.9 | | | |
| | | | oxirane(UVR-6105) | | | | |
| | | | Monofunctional oxetane | 60.0 | | | |
| | | | (OXT-211) | | | | |
| | | | Monofunctional oxetane | 3.6 | | | |
| | | | (OXT-212) | | | | |
| Ex. 2 | 33 | Magenta | Polyfunctional oxetane | 11.0 | 59.2 | Good | Good |
| | | | (OXT-221) | | | | |
| | | | Polyfunctional | 11.9 | | | |
| | | | oxirane(UVR-6105) | | | | |
| | | | Monofunctional oxetane | 52.0 | | | |
| | | | (OXT-211) | | | | |
| | | | Monofunctional oxetane | 7.2 | | | |
| | | | (OXT-212) | | | | |
| Ex. 3 | 34 | Yellow | Polyfunctional oxetane | 11.0 | 59.2 | Good | Good |
| | | | (OXT-221) | | | | |
| | | | Polyfunctional | 11.9 | | | |
| | | | oxirane(UVR-6105) | | | | |
| | | | Monofunctional oxetane | 52.0 | | | |
| | | | (OXT-211) | | | | |
| | | | Monofunctional oxetane | 7.2 | | | |
| | | | (OXT-212) | | | | |
| Ex. 4 | 31 | Black | Polyfunctional oxetane | 11.0 | 63.6 | Good | Good |
| | | | (OXT-221) | | | | |
| | | | Polyfunctional | 9.9 | | | |
| | | | oxirane(UVR-6105) | | | | |
| | | | Monofunctional oxetane | 60.0 | | | |
| | | | (OXT-211) | | | | |
| | | | Monofunctional oxetane | 3.6 | | | |
| | | | (OXT-212) | | | | |
| Ex. 5 | 36 | White | Polyfunctional oxetane | 10.0 | 53.5 | Good | Good |
| | | | (OXT-221) | | | | |
| | | | Polyfunctional | 8.9 | | | |
| | | | oxirane(UVR-6105) | | | | |
| | | | Monofunctional oxetane | 40.0 | | | |
| | | | (OXT-211) | | | | |
| | | | Monofunctional oxetane | 13.5 | | | |
| | | | (OXT-212) | | | | |
| Ex. 6 | 28 | Cyan | Polyfunctional oxetane | 11.0 | 63.6 | Good | Good |
| | | | (OXT-221) | | | | |
| | | | Polyfunctional | 9.9 | | | |
| | | | oxirane(UVR-6105) | | | | |
| | | | Monofunctional oxetane | 60.0 | | | |
| | | | (Compound example A) | | | | |
| | | | Monofunctional oxetane | 3.6 | | | |
| | | | (OXT-212) | | | | |
| Ex. 7 | 28 | Cyan | Polyfunctional oxetane | 11.0 | 63.6 | Good | Good |
| | | | (OXT-221) | | | | |
| | | | Polyfunctional | 9.9 | | | |
| | | | oxirane(UVR-6105) | | | | |
| | | | Monofunctional oxetane | 30.0 | | | |
| | | | (OXT-211) | | | | |
| | | | Monofunctional | 30.0 | | | |
| | | | oxirane(Compound | | | | |
| | | | example B) | | | | |
| | | | Monofunctional oxetane | 3.6 | | | |
| | | | (OXT-212) | | | | |
| Ex. 8 | 32 | Cyan | Polyfunctional oxetane | 11.0 | 63.6 | Good | Good |
| | | | (OXT-221) | | | | |
| | | | Polyfunctional | 9.9 | | | |
| | | | oxirane(UVR-6105) | | | | |
| | | | Monofunctional oxetane | 45.0 | | | |
| | | | (OXT-211) | | | | |
| | | | Monofunctional vinyl ether | 15.0 | | | |
| | | | (CHMVE) | | | | |
| | | | Monofunctional oxetane | 3.6 | | | |
| | | | (OXT-212) | | | | |
| Ex. 9 | 28 | White | Polyfunctional oxetane | 10.0 | 40.0 | Good | Good |
| | | | (OXT-221) | | | | |
| | | | Polyfunctional | 9.5 | | | |
| | | | oxirane(UVR-6105) | | | | |
| | | | Polyfunctional vinyl ether | 10.9 | | | |
| | | | (DVE-3) | | | | |
| | | | Monofunctional oxetane | 26.5 | | | |
| | | | (OXT-211) | | | | |
| | | | Monofunctional oxetane | 13.5 | | | |
| | | | (OXT-212) | | | | |
| Comp. | 27 | Cyan | Polyfunctional oxetane | 45.0 | 3.6 | Embossed | Vacuum- |
| Ex. 1 | | | (OXT-221) | | | image | formed |
| | | | Polyfunctional | 35.9 | | partially | image |
| | | | oxirane(UVR-6105) | | | cracked. | partially |
| | | | Monofunctional oxetane | 3.6 | | | cracked. |
| | | | (OXT-212) | | | | |
| Comp. | 29 | Cyan | Polyfunctional oxetane | 28.9 | 23.6 | Embossed | Vacuum- |
| Ex. 2 | | | (OXT-221) | | | image | formed |
| | | | Polyfunctional | 32.0 | | partially | image |
| | | | oxirane(UVR-6105) | | | cracked. | partially |
| | | | Monofunctional oxetane | 20.0 | | | cracked. |
| | | | (OXT-211) | | | | |
| | | | Monofunctional oxetane | 3.6 | | | |
| | | | (OXT-212) | | | | |

The amount of OXT-212 is the amount contained in the mill base introduced into each formulation.

What is claimed is:

1. A process for producing a molded printed material comprising:
(A) a step of forming an image by discharging an ink composition on a support by an inkjet method, the ink composition comprising at least one compound of monofunctional cationically polymerizable monomer selected from the group consisting of an oxetane compound, an oxirane compound, and a vinyl ether compound, and the proportion of the monofunctional cationically polymerizable monomer in the entire ink composition being at least 30 wt %;
(B) a step of curing the ink composition by irradiating with actinic radiation the image obtained so as to obtain a printed material having the image cured on the support; and
(C) a step of molding the printed material.

2. The process for producing a molded printed material according to claim 1, wherein the monofunctional cationically polymerizable monomer is a cyclic structure-containing monomer.

3. The process for producing a molded printed material according to claim 2, wherein the proportion of the cyclic structure-containing monofunctional cationically polymerizable monomer in the entire ink composition is at least 25 wt % but no greater than 80 wt %.

4. The process for producing a molded printed material according to claim 2, wherein the cyclic structure-containing monofunctional cationically polymerizable monomer is a monofunctional oxetane compound.

5. The process for producing a molded printed material according to claim 1, wherein the monofunctional cationically polymerizable monomer comprises a low-polarity monofunctional oxetane compound and/or a low-polarity monofunctional oxirane compound.

6. The process for producing a molded printed material according to claim 1, wherein the ink composition comprises a polyfunctional oxetane compound and/or a polyfunctional oxirane compound, the total amount of the polyfunctional oxetane compound and/or polyfunctional oxirane compound being less than 25 wt % of the entire ink composition.

7. The process for producing a molded printed material according to claim 1, wherein the ink composition comprises the polyfunctional oxetane compound, the total amount of the oxetane compound being less than 15 wt % of the entire ink composition.

8. The process for producing a molded printed material according to claim 6, wherein the ink composition comprises a polyfunctional oxetane compound and a polyfunctional oxirane compound.

9. The process for producing a molded printed material according to claim 1, wherein the molding is embossing, vacuum forming, pressure forming, or vacuum/pressure forming.

10. A molded printed material obtained by the process for producing a molded printed material according to claim 1.
